(19) United States
(12) Patent Application Publication
(10) Pub. No.: US 2025/0188901 A1
(43) Pub. Date: Jun. 12, 2025

(54) Manufacturing Cementitious Bodies on Floating Platforms

(71) Applicant: RCAM Technologies, Inc., Boulder, CO (US)

(72) Inventors: Jason Rust Cotrell, Boulder, CO (US); Mason James Bell, Long Beach, CA (US); Jacob Daniel Blum, Sausalito, CA (US)

(73) Assignee: RCAM Technologies, Inc., Boulder, CO (US)

(21) Appl. No.: 19/056,355

(22) Filed: Feb. 18, 2025

Related U.S. Application Data
(63) Continuation-in-part of application No. 18/300,168, filed on Apr. 13, 2023, now abandoned.
Application No. 18/300,168 is a continuation of application No. 17/681,133, filed on Feb. 25, 2022, now Pat. No. 11,655,794.
Application No. 17/681,133 is a continuation of application No. PCT/US2021/026558, filed on Apr. 9, 2021.
(60) Provisional application No. 63/007,558, filed on Apr. 9, 2020.

(51) Int. Cl. F03B 13/06; F03D 9/00; F03D 9/28

(52) U.S. Cl. CPC F03B 13/06; F03D 9/008; F03D 9/28; F05B 2240/40; F05B 2240/95; F05B 2240/97; F05B 2250/241; F05B 2260/422; F05B 2270/18

(57) ABSTRACT

In a general aspect, a submersible barge includes a deck having a support surface and an additive manufacturing system. The submersible barge may be deployed on a body of water. The additive manufacturing system is configured to fabricate a cementitious body on the support surface by successively depositing layers of flowable cementitious material on top of each other. The submersible barge also includes a buoyancy system that is configured to lower the cementitious body into the body of water by altering a draft of the submersible barge between first and second drafts. When the submersible barge is at the first draft, the support surface resides above a surface of the body of water. When the submersible barge is at the second draft, the support surface resides below the surface of the body of water.

### CROSS-REFERENCE TO RELATED APPLICATIONS

This application is a continuation-in-part of U.S. patent application Ser. No. 18/300,168, filed Apr. 13, 2023 and entitled “Marine-Pumped Hydroelectric Energy Storage,” which is a continuation of U.S. patent application Ser. No. 17/681,133, filed Feb. 25, 2022 and entitled “Marine-Pumped Hydroelectric Energy Storage,” which is a continuation of PCT Application No. PCT/US2021/026558, filed Apr. 9, 2021 and also entitled “Marine-Pumped Hydroelectric Energy Storage,” which claims priority to U.S. Provisional Application No. 63/007,558, which was filed on Apr. 9, 2020 and is entitled, “Industrialized Ocean-Energy-Storage.” The disclosures of these priority applications are hereby incorporated by reference in their entirety.

### BACKGROUND

The following description relates to manufacturing cementitious bodies on floating platforms.

Manufacturing offshore energy foundations and assembling components on those foundations can require substantial land area and high-capacity wharves. The foundations may have shapes and features that are challenging to achieve with conventional material stock. Moreover, the foundations may have sizes that require a significant amount of material for their manufacture.

### DESCRIPTION OF DRAWINGS

FIG. 1 is a schematic diagram of various examples of marine-pumped hydroelectric (MPH) technology deployed in an offshore environment;

FIG. 2A is a schematic diagram, in perspective view, of an example system for storing energy underwater;

FIG. 2B is a schematic diagram, in perspective view, of the example system of FIG. 2A, but with two domed walls and an anchor absent;

FIG. 2C presents a schematic diagram, in perspective view, of two instances of the example system of FIG. 2A coupled to each other through a mating mechanical interface;

FIG. 3 is a schematic diagram, in perspective view, of an example system having a base that includes a conduit system;

FIG. 4A is a schematic diagram, in perspective view, of an example system that includes a pump housing, a generator housing, and a combined pump/generator housing that are external to fluid chambers of the example system;

FIG. 4B is a schematic diagram, in perspective view, of the example system of FIG. 4A, but in which each fluid chamber has a portion of a combined pump/generator housing internal thereto;

FIG. 5 is a schematic diagram, in perspective view, of an example system that includes a hexagonal array of domed walls extending from a base;

FIG. 6A is a schematic diagram, in perspective view, of an example linear-shaped system for storing energy underwater;

FIG. 6B is a schematic diagram, in top view, of the example linear-shaped system 600 of FIG. 6A;

FIG. 7 is a schematic diagram, in top view, of an example rectangular-shaped system for storing energy underwater;

FIG. 8 is a schematic diagram, in cross-section, showing examples of a pump assembly, a generator assembly, and a combined pump/generator assembly for an underwater energy storage system;

FIG. 9 is a schematic diagram showing stages of an example 3D Concrete Printing (3DCP) process used to fabricate a domed wall;

FIG. 10 is a schematic diagram of an example onshore manufacturing plant that includes a rail and jacking system for moving marine caissons;

FIG. 11 is a schematic diagram of an example graving dry dock;

FIG. 12A is a schematic diagram, shown in perspective view, of an example dry-dock floating platform that is stationed at a dock and contains multiple MPH systems therein;

FIG. 12B is a schematic diagram, in top view, of the example dry-dock floating platform of FIG. 12A;

FIG. 13A is a schematic diagram, in perspective view, of the example submersible barge located on a body of water;

FIG. 13B is a schematic diagram, in top view, of the example submersible barge of FIG. 13A;

FIG. 14 is a schematic diagram of an example wet-tow process that includes multiple MPH systems being towed by tugboats on the surface of a body of water;

FIG. 15 is a schematic diagram of an example floating dry dock;

FIG. 16A is a schematic diagram, in perspective view, of an example multi-purpose semi-submersible vessel floating in a body of water;

FIG. 16B is a schematic diagram, in elevation view, of the example multi-purpose semi-submersible vessel of FIG. 16A in which the vessel is lifting a marine-pumped hydro system from a barge and lowering it into the water;

FIG. 17A is a schematic diagram, in perspective view, of an example floating shiplift manufacturing a cementitious body on its elevator.

FIG. 17B is a schematic diagram, in top and cross-section views, of example configurations a deck and elevator of the example floating shiplift of FIG. 17A.

FIG. 18A is a schematic diagram of an example floating shiplift that includes a 3D printed concrete body and is being lowered into a body of water adjacent a port;

FIG. 18B is a schematic diagram of the floating shiplift of FIG. 18A but floating in the body of water;

FIG. 19 is a schematic diagram, in bottom perspective view, of an example deck caisson for a floating shiplift;

FIG. 20 is a schematic diagram, in perspective view, of an example floating shiplift that includes a slip-forming frame on a deck of the FS;

FIG. 21 is a schematic diagram, in top view, of example aspect ratios for a floating shiplift;

FIG. 22A is a schematic diagram, in exploded perspective view, of an example floating shiplift having its deck and elevator disengaged;

FIG. 22B is a schematic diagram, in perspective view, of the example floating shiplift of FIG. 22A but in which the deck and elevator are engaged;

FIG. 23 is a schematic diagram, in perspective view, an example floating shiplift island that includes four floating shiplift stations;

FIG. 24 is a schematic diagram of an example “feedering” process in which components of a FOW turbine are transported out to a wind turbine installation vessel;

FIG. 25 is a schematic diagram showing an example “feedering” process that uses four floating shiplift stations;

FIG. 26A is a schematic diagram, in perspective view, of an example deck caisson 2600 having two mechanical interfaces with respective male and female portions and channels into which reinforcement materials may be inserted;

FIG. 26B is a schematic diagram, in perspective view, of the example deck caisson of FIG. 26A but in which the two mechanical interfaces are interlocked with the mechanical interfaces of neighboring deck caissons; and

FIG. 26C is a schematic diagram, in transparent view, of the example deck caisson of FIG. 26B but showing the details of the two interlocked mechanical interfaces, including the channels for the reinforcement materials.

### DETAILED DESCRIPTION

Aspects of what is described here relate to the manufacturing of cementitious bodies on floating platforms. The cementitious bodies may be part of or define a structure for marine applications. The structure may, for example, be a foundation for a wind turbine, a wave energy converter, or an offshore solar system. The structure may also be a dome or a base for a marine-pumped hydroelectric system. Other types of marine structures are possible, such as an anchor, a caisson an artificial reef, and so forth. To manufacture the cementitious bodies, the floating platforms may include an additive manufacturing system (e.g., a 3D printer, a spray system, a slip-forming system, etc.). In some implementations, the floating platforms are configured to launch the cementitious bodies into, or retrieve them from, a body of water. The floating platforms may float, in whole or in part, on this body of water.

In certain aspects, the cementitious bodies support technologies for marine-pumped hydroelectric (MPH) power. Such technologies can provide a low risk, low cost, and long-term energy storage solution. The technologies can also include industrialized underwater energy storage systems, devices and components, and related methods of installation, operation, maintenance, and recovery.

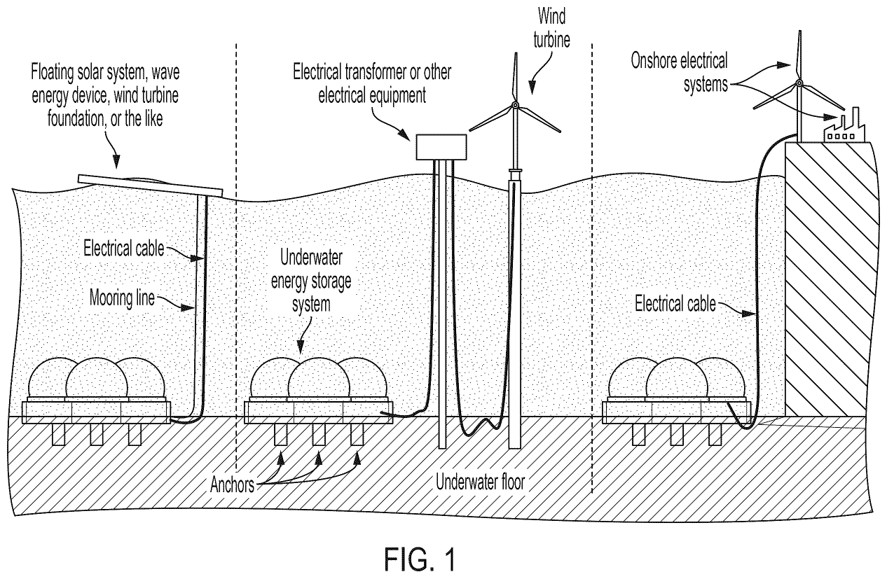

In some aspects of operation, MPH technologies can extract, store, and utilize energy from hydrostatic pressure in oceans, lakes, or other types of natural or manmade bodies of water. To use this potential energy, a large hollow concrete vessel can be installed in deep water, and a pump-turbine associated with the hollow sphere allows the storing of electrical energy. For example, to store energy, water can be pumped out of the hollow sphere against the pressure of the surrounding water, and the process can be reversed to generate electricity. MPH technologies can be deployed in a variety of subsea or other underwater environments, for example, in deep lakes and oceans (e.g., approximately 100-m to 2000-m deep) and other environments. MPH technologies can also operate in coordination with other systems and equipment, for example, to provide energy storage for floating offshore equipment, fixed-bottom offshore equipment, onshore electrical equipment, or a combination of electrical systems. Examples of such coordination are described below in relation to FIG. 1.

MPH technologies can be utilized virtually throughout the world, including, North America, Europe, Asia, Australia, and South America. For example, the MPH technologies described herein can be deployed in the deep lakes and oceans of the United States, such as those on the U.S. West Coast, East Coast, and Great Lakes. As an example of the energy potential of MPH technologies, California is estimated to have approximately 100 GW of underwater pumped energy storage resource potential, which is about 25 times California's existing installed pumped hydropower power capacity.

In some instances, the MPH technologies can be implemented with a modular design that is highly scalable for deployments with power capacities as little as 100 kW to 10 MW per storage sphere. The long-term energy storage provided by these technologies could help enable economic development of 120 GW of floating offshore wind energy potential along California's 800 miles of coastline. This offshore wind energy potential corresponds to about $1 trillion worth of wind plant installations, which could produce about one and a half times all the electricity currently consumed by California. As another example, integrating systems based on the MPH technologies with a single offshore wind plant of 2 GW capacity (about 200 turbines) may provide as much electrical energy production as the Hoover Dam can generate in 4 hours at full capacity.

In some instances, aspects of the MPH technologies described herein can provide advantages and improvements over conventional, ocean-based underwater pumped hydro systems. These advantages and improvements may, for example, ease installation, maintenance, recovery, and manufacturing of such systems, thereby reducing costs in all water depths. In some examples, advantages are obtained by coupling several storage spheres to a single generator/pump assembly. This coupling can reduce the overall cost of an energy storage system (e.g., for all water depths) by reducing the number of parts and providing easier access for generator/pump maintenance and inlet/outlet screen cleaning. The cost reduction is notable for systems in shallow water (e.g., in the U.S. Great Lakes) in which more spheres are needed to counteract the effects of the reduced hydrostatic pressure that results from the lower submersion depth. Moreover, the use of numerous interconnected storage spheres, instead of one large storage sphere, may reduce the overall size of the storage spheres. This reduced overall size can be manufactured more easily while still allowing for a similar amount of energy storage capacity (e.g., reducing the storage spheres from 30-m in diameter to 10-m in diameter).

A rigid coupling of several storage spheres is also possible. Such rigid coupling, along with the use of a concrete base, may increase the ability to tow the storage sphere(s) in shallow ports. The rigid coupling may also provide additional mass needed to anchor the sphere, and increase the stability of the entire system during towing and installation. This increased stability may result by the concrete base creating a shape that acts as a raft or barge. The concrete base may also lower the center of gravity of the system. Further advantages can be obtained by utilizing a base and domes designed to facilitate automated 3D concrete printing, alternative concrete manufacturing methods such as spraying or pre-casting concrete, or manufacturing of smaller modular or sectional components that may reduce the overall cost of the structure. In some cases, the base cavities, domes, and access lid are easier to print in sections because they may reduce overhangs that are difficult to print compared to printing an entire sphere continuously, and because the base can provide support surfaces to print the cavities.

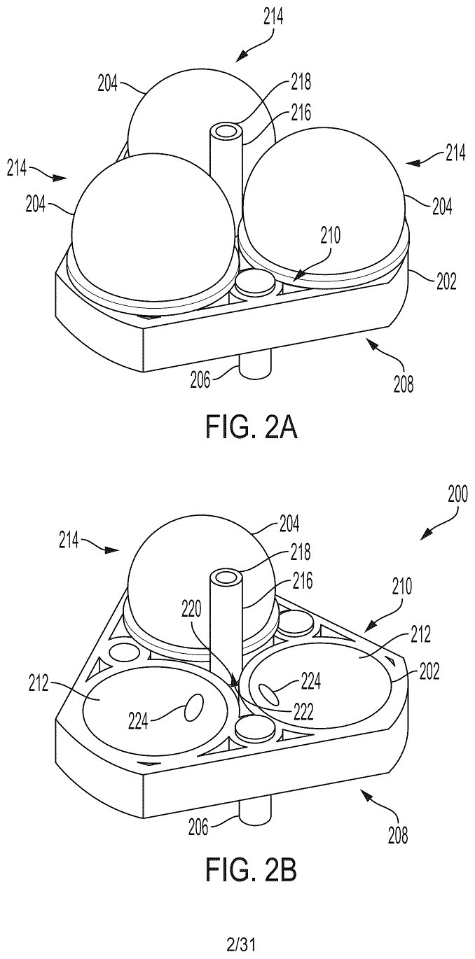

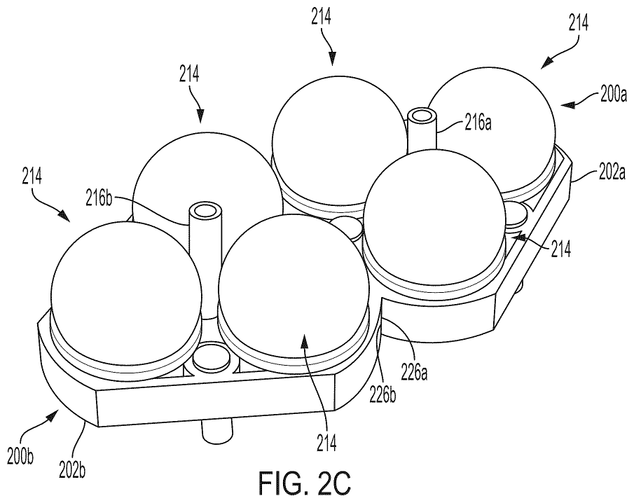

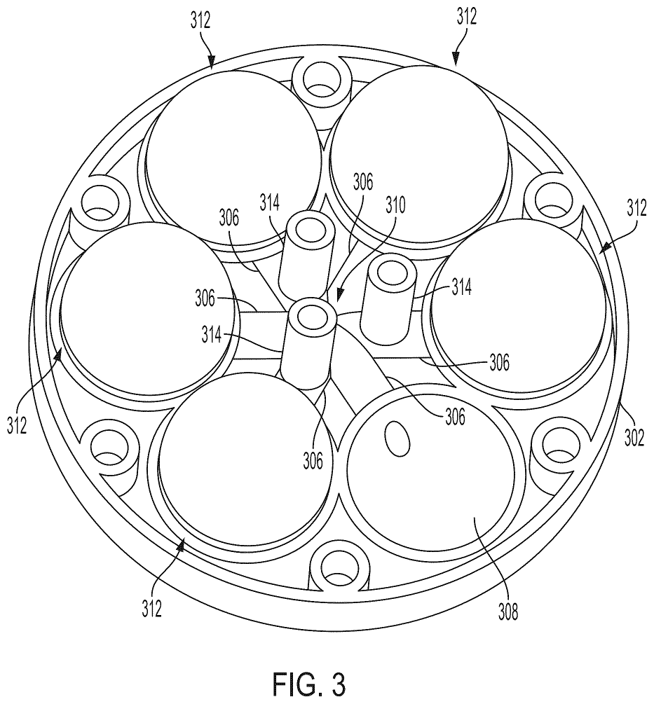

Now referring to FIG. 1, a schematic diagram is presented of various examples of MPH technology deployed in an offshore environment. MPH technology, however, may also be deployed in another environment. The various examples of MPH technology include an example underwater energy storage system that is anchored to the sea floor. In some instances, the example underwear energy storage system includes a mooring line, such as to couple to another structure (e.g., a floating solar system, wave energy device, wind turbine foundation, etc.). In some instances, the example underwater storage system includes an electrical cable for communicating electrical energy, such as with a transformer, a source of electrical energy (e.g., a floating solar system, a wave energy device, a wind turbine, etc.), an on-shore electrical system, and so forth. The example underwater energy storage system is also shown in FIGS. 2A-2B. For example, FIG. 2B presents the example underwater storage system with two of three pressure domes absent and one anchor removed to help show features of a base subcomponent. The MPH technologies described herein may allow for other configurations of the underwater energy storage system. For example, the configurations may include additional or different features, and the components may be arranged in another manner.

In some aspects of operation, the example underwater energy storage system shown in FIGS. 1 and 2A-2B can interact with other systems (e.g., the other systems shown in FIG. 1) to receive input energy (e.g., for long term storage) or provide output energy (e.g., for consumption or other applications). The physical principle of operation may be similar to the concept of conventional pumped-hydroelectric storage plants located onshore. A concrete hollow sphere is placed deep underwater on an underwater floor. To store input energy—e.g., during periods when wind and/or photovoltaic systems produce a high amount of electricity by wind, or when the price of electricity on the wholesale market is low—a pump turbine pumps water out of the hollow sphere. In some cases, the evacuated water is not replaced by atmospheric air in the hollow sphere, which may result in a pressure at or below atmospheric pressure in the hollow sphere. To provide output energy—e.g., during periods of high electricity demand, or when electricity prices are high-high pressure water surrounding the hollow sphere is allowed to flow back into the hollow sphere through a turbine and generator, which in response to this flow, generates electricity.

As shown in FIGS. 1 and 2A-2B, the example underwater energy storage system includes three pressure domes. The three pressure domes are combined with a spherical bottom enclosure to form three storage spheres. The example underwater energy storage system also includes a base, which may contain the bottom enclosure of the storage spheres. The example underwater energy storage system additionally includes a pump/generator assembly and anchors.

In many implementations, the example underwater energy storage system includes multiple storage spheres. In these implementations, one or more pressure domes may interface with the base to create an approximately spherical rigid volume. The spherical rigid volume may include an inlet and/or an outlet that allows water to flow into and/or out of the spherical rigid volume. Such flow may allow a pump/generator assembly to consume or generate electricity.

In many implementations, the example underwater energy storage system includes a base. The base can be configured to achieve one or more functions. For example, the base may: (1) create an enclosure (e.g., a spherical enclosure) in conjunction with the pressure domes; (2) provide ports, conduits, or pipes to channel the water from the enclosures through one or more pumps/generators, to an inlet and/or an outlet, or other pressure domes if desired; (3) provide a mount for a pump/generator assembly; (4) provide a structure through which to anchor the system using anchors such as piles or suction anchors; (5) provide a coupling interface for joining one or more modules (e.g., as shown in FIG. 2C); (6) provide one or more buoyancy chambers to facilitate transport, installation, and recovery of the storage module; (7) act as a barge to facilitate floatation and stability during towing, installation, or retrieval of the module; or (8) provide additional mass needed to hold the module down when the storage spheres are empty.

Now referring to FIG. 2A, a schematic diagram is presented, in perspective view, of an example system 200 for storing energy underwater. The example system 200 is configured to operate in an underwater environment, such as when secured to an underwater floor (e.g., as shown in FIG. 1 or otherwise). The system 200 may operate while fully submerged in a body of water, for example, in a deep lake, an ocean, a sea, a reservoir, or another body of water. The system 200 may be anchored or otherwise secured to a seafloor, a lakebed, an underwater platform, or another type of underwater floor.

The example system 200 includes a base 202 and a plurality of domed walls 204. FIG. 2B presents a schematic diagram, in perspective view, of the example system 200 of FIG. 2A, but with two domed walls 204 and an anchor 206 absent. The base 202, which may be generally tabular in shape, has a bottom side 208 configured to rest on an underwater floor and a top side 210 that includes a plurality of recessed surfaces 212. During operation, the bottom side 208 of the base 202 rests on the underwater floor and may be anchored thereto via one or more anchors 206. In some variations, such as shown in FIG. 2B, the plurality of recessed surfaces 212 are defined by spherical cap-shaped depressions in base 202 on the top side 210. However, other types of depressions or shapes are possible.

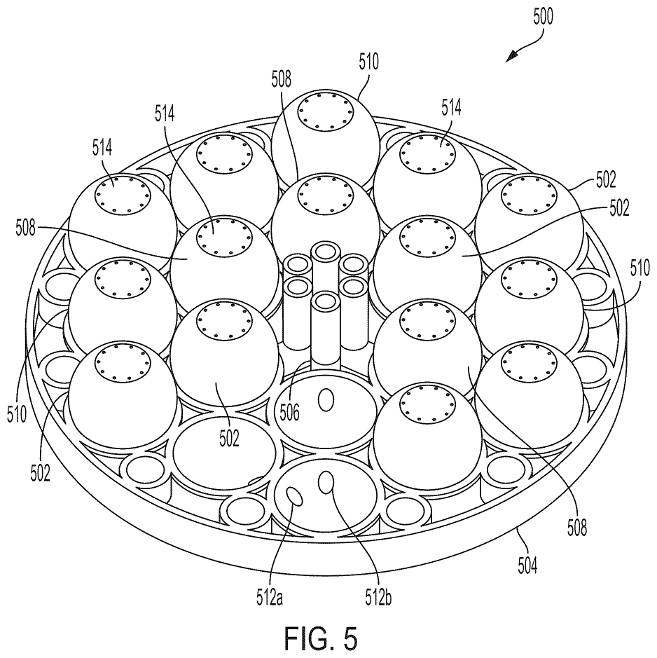

The plurality of domed walls 204 extend from the top side 210 of the base 202 to form respective fluid chambers 214. Each of the fluid chambers 214 includes an interior volume that is defined by one of the recessed surfaces 212 and an interior surface of one of the domed walls 204. The interior surface of each domed wall 204 bounds a partially-enclosed volume of the domed wall 204. Moreover, a perimeter edge of the domed wall 204 encircles an opening into the partially-enclosed volume. In many variations, such as shown in FIGS. 2A-2B, the interior surface of each domed wall 204 faces a respective recessed surface 212 and is aligned therewith. In some variations, one or more of the domed walls 204 may include an access lid or hatch (e.g., as shown in FIG. 5) to provide selective access to the interior volume of an associated fluid chamber. The access lid or hatch may be positioned on the domed wall 204 opposite the top side 210 of the base 202.

FIGS. 2A-2B present each of the fluid chambers 214 as being spherical. In this configuration, the interior surfaces of the domed walls 204 and recessed surfaces 212 correspond to spherical cap-shaped surfaces that join, in respective pairs, to complete a spherical surface. However, other shapes are possible for the domed walls 204, the recessed surfaces 212, and the fluid chambers 214 (e.g., spheroidal, cylindrical, frustoconical, or an irregular shape). In some cases, the domed walls 204 and the recessed surfaces 212 have cap-shaped surfaces of different radii or other distinct geometric properties. Alternative shapes for the fluid chambers 214 could also be used to replace the domed walls 204, for instance, with tubular walled structures (e.g., pipes). However, domed wall shapes may provide certain advantages. For example, compared to a tubular structure, a spherical shape may require approximately only one-half the material for construction for a given volume and pressure. The lower amount of material may be due to an ability of the spherical shape to equally balance compressive hydrostatic forces.

In some implementations, the base 202 and the plurality of domed walls 204 are an integral body. For example, the base 202 and each of the domed walls 204 may be formed of the same material, without distinct edges or separation between the base 202 and the respective domed walls 204. In some implementations, such as shown in FIGS. 2A-2B, the base 202 and the plurality of domed walls 204 are separate bodies. In these implementations, each of the domed walls 204 includes a perimeter edge encircling an opening of the domed wall 204. The perimeter edge may be sealed to the top side 210 of the base 202. In many instances, the base 202 and the plurality of domed walls 204 are rigidly coupled to each other.

In some variations, the example system 200 includes various ports, conduits, tubes, or other structures that define one or more flow paths through the example system 200, including a first and second flow path. In some cases, the first and second flow paths include shared flow path sections, or they may be entirely distinct flow paths. In some cases, an individual flow path may include one or more branches or sections that flow in parallel, such as to or from different inlets or outlets. The first flow path may provide fluid communication through the pump, between the fluid chambers 214 and the exterior environment. As such, at least a portion of the first flow path is provided by the pump in the example system 200. The first flow path may also extend through part of the base 202 or other components of the example system 200. The second flow path may provide fluid communication through the generator, between the fluid chambers 214 and the exterior environment. As such, at least a portion of the second flow path is provided by the generator in the example system 200. The second flow path may also extend through part of the base 202 or other components of the system 200.

The example system 200 also includes a pump and a generator. The pump is configured to transport water from the fluid chambers 214 toward the exterior environment of the example system 200, such as along the first flow path. During operation, the pump causes water to flow from the interior volumes of the fluid chambers 214 into the body of water in which the example system 200 operates. In some variations, the pump includes a turbine configured to convert mechanical energy (e.g., a motion of turbine surfaces) into hydraulic energy (e.g., a flow or pressure of water). For example, the turbine may include blades or vanes that, during motion, contact the water to induce a flow of the water. The generator is configured to generate electrical energy in response to water flowing from the exterior environment toward the fluid chambers 214, such as along the second flow path. During operation, the generator responds to water flowing from the body of water in which the example system 200 operates into the interior volumes of the fluid chambers 214. In many variations, the generator includes a turbine with turbine surfaces configured to contact the flowing water and convert hydraulic energy into mechanical energy (e.g., a motion of the turbine surfaces). For example, the flowing water may contact blades or vanes of the turbine to induce their motion (e.g., rotation, translation, etc.).

In some implementations, such as shown in FIGS. 2A-2B, the example system 200 includes a housing 216 that contains both the pump and the generator (e.g., contains a combined pump/generator assembly). The housing 216 may be coupled to the base, or in some instances, the housing 216 may be integral to the base. In these implementations, the housing 216 includes a first housing port 218 and a second housing port 220. For example, the housing 216 may include a tubular structure extending between two open ends that serve as respective ports (e.g., an inlet, an outlet, etc.). A third flow path extends between the fluid chambers 214 and the exterior environment of the system and comprises at least a portion extending through the housing 216 between the first and second housing ports 218, 220. The pump is configured to pump water along the third flow path from the fluid chambers 214 toward the exterior environment, and the generator is configured to generate electrical energy in response to water flowing along the third flow path from the exterior environment into the fluid chambers 214.

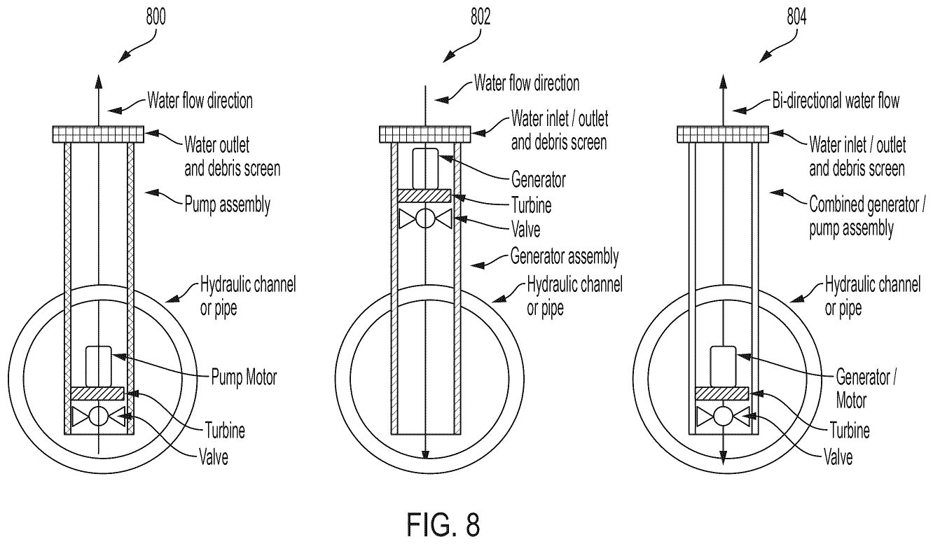

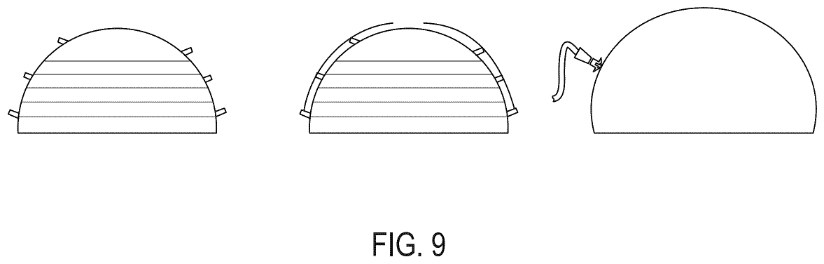

Although FIGS. 2A-2B illustrate the pump and the generator as contained within a single housing, other configurations are possible. For example, in some implementations, the example system 200 includes a pump housing and a generator housing. The pump housing contains the pump and includes first and second pump housing ports. Similarly, the generator housing contains the generator and includes first and second generator housing ports. One or both of the pump and generator housing may be coupled to the base 202. In some implementations, the first flow path extends between the fluid chambers 214 and the exterior environment of the example system 200 and includes at least a portion extending through the pump housing between the first and second pump housing ports. The pump is configured to pump water along the first flow path from the fluid chambers 214 toward the exterior environment. In these implementations, the second flow path, which is distinct from the first flow path, extends between the fluid chambers 214 and the exterior environment and includes at least a portion extending through the generator housing between the first and second generator housing ports. The generator is configured to generate electrical energy in response to water flowing along the second flow path from the exterior environment toward the fluid chambers 214. Further examples of housing configurations for the pump and the generator are described below in relation to FIG. 8.

The pump, the generator, or both may correspond to respective assemblies—e.g., a pump assembly, a generator assembly, and a combined pump/generator assembly-that engage water flowing into or out of the fluid chambers 214. For example, the pump assembly can include components such as a pump, a turbine, water ports, one or more valves, a debris screen, and so forth; the generator assembly can include components such as a generator, a turbine, water ports, one or more valves, a debris screen, and so forth; and the combined pump/generator assembly can include components such as a pump, a generator, a turbine, water ports, one or more valves, a debris screen, and so forth. Some of the components of these assemblies may be coupled to or integrated into a respective housing (e.g., a pump housing, a generator housing, a single unified housing, etc.) In some implementations, the example system 200 includes one or more generator assemblies or one or more combined pump/generator assemblies to generate electricity when water is flowing into the fluid chambers 214. The flow direction is reversed when the fluid chambers 214 are used to store energy, e.g., by pumping water out of the fluid chambers 214 using one or more pump assemblies or the one or more combined pump/generator assemblies. In these implementations, electricity to and from the example system 200 may be routed through an electrical cable to a surface of the water, such as to an electrical system on an offshore platform.

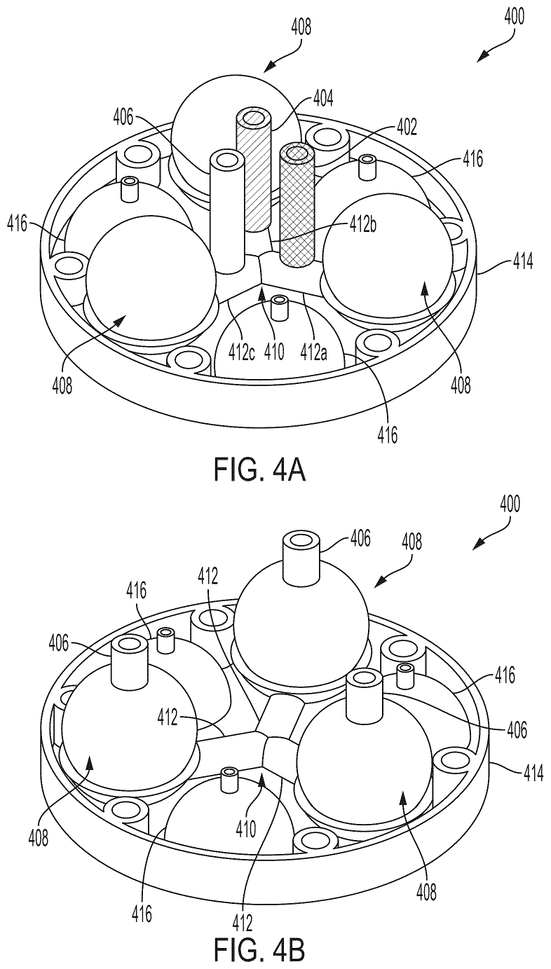

The pump, generator, and combined pump/generator assemblies may be located external to the fluid chambers 214. For example, FIG. 4A presents a schematic diagram, in perspective view, of an example system 400 that includes a pump housing 402, a generator housing 404, and a combined pump/generator housing 406 that are external to fluid chambers 408. The example system 400 may be analogous to the example system 200 described in relation to FIGS. 2A-2B. The pump housing 402, the generator housing 404, and the combined pump/generator housing 406 may contain, respectively, a pump assembly, a generator assembly, and a combined pump/generator assembly. In some cases, the pump, generator, and combined pump/generator assemblies may be located internal to one or more of the fluid chambers 408. For example, FIG. 4B presents a schematic diagram, in perspective view, of the example system 400 of FIG. 4A, but in which each fluid chamber 408 has a portion of a combined pump/generator housing 406 internal thereto.

In some instances, locating the assemblies externally may ease the removal and replacement of such assemblies for maintenance purposes. Such external location may also allow the fluid chambers to utilize a reduced number of assemblies. This reduced number may lower the parts needed to support an MPH system as well as increase its storage capacity (relative to its power generation capacity). Increasing the storage capacity may be economically preferable for installations in shallow water where hydrostatic pressures are lower. However, other deployments may also benefit from an increased storage capacity. In some configurations, such as shown in FIG. 4B, the system 400 may include separate pump and generator assemblies. Separating the pump and generator assemblies may allow the pump and generator to run independently or simultaneously, if needed, to provide nearly immediate electrical production without delaying equipment startup. It will be appreciated that the assemblies—e.g., the pump assembly, the generator assembly, and the combined pump/generator assembly-along with components thereof (e.g., the water inlet/outlets, debris screens, etc.) may be designed to match a configuration of the example system 200, a means of transport and installation, and a deployment location. Other criteria are possible.

Now referring back to FIGS. 2A-2B, the base 202 of the example system 200 may include a conduit system 222 providing fluid communication between the fluid chambers 214. For example, FIG. 3 presents a schematic diagram, in perspective view, of an example system 300 having a base 302 that includes a conduit system 304. The example system 300 may be analogous to the example system 200 described in relation to FIGS. 2A-2B. The conduit system 304 includes individual conduits 306 extending from recessed surfaces 308 of the base 302 to meet at a central union 310. This configuration allows the conduit system 304 to provide fluid communication between the fluid chambers 312. Now referring back to FIGS. 2A-2B, in some variations, the conduit system 222 may be integral to the base 202. For example, the base 202 may include interior surfaces defining the conduit system 222, such as through walls integral to the base 202. In some variations, the recessed surfaces 212 on the top side 210 of the base define respective conduit ports 224 to the conduit system 222.

In some implementations, the conduit system 222 provides fluid communication between the pump and the fluid chambers 214 and defines at least part of a flow path (e.g., the first flow path) extending between the fluid chambers 214 and the exterior environment of the system. For example, as shown in FIG. 4A, the system 400 may include a conduit system 410 having a first conduit 412a with a port disposed therein. The pump housing 402, which contains a pump (or pump assembly), may include a pump housing port that is coupled to the port of the first conduit 412a. However, in some variations, the pump housing 402 is disposed through a wall of the first conduit 412a—e.g., through the port of the first conduit 412a-such that the pump housing port resides in the first conduit 412a. An example of such a configuration is shown in the leftmost illustration of FIG. 8. Although FIG. 4A illustrates only a single pump housing, multiple pump housings and respective first flow paths are possible.

In some implementations, the conduit system 222 provides fluid communication between the generator and the fluid chambers 214 and defines at least part of a flow path (e.g., the second flow path) extending between the fluid chambers 214 and the exterior environment of the system. For example, the conduit system 410 of FIG. 4A may include a second conduit 412b with a port disposed therein. The generator housing 404, which includes a generator (or generator assembly), may include a generator housing port that is coupled to the port of the second conduit 412b. However, in some variations, the generator housing 404 is disposed through a wall of the second conduit 412b—e.g., through the port of the second conduit 412b-such that the generator housing port resides in the second conduit 412b. An example of such a configuration is shown in the center illustration of FIG. 8. Although FIG. 4A illustrates only a single generator housing, multiple generator housings and respective second flow paths are possible.

In implementations where the pump and the generator are contained in separate housings or as distinct assemblies, such a configuration may allow for an instant energy generation response. For example, while the pump operates to store energy, the generator may operate concomitantly at a lower power level. This tandem operation may reduce or avoid a “startup” delay in generating power.

In some implementations, the conduit system 222 provides fluid communication between the fluid chambers 214 and both the pump and the generator. In these implementations, the conduit system 222 defines at least part of a flow path (e.g., the third flow path) extending between the fluid chambers 214 and the exterior environment of the system. The flow path is common to the pump and the generator. For example, the conduit system 222 may include a port coupled to the second housing port 220 of the housing 216. (The housing 216 contains both the pump and the generator.) In another example, and as shown in FIG. 4A, the conduit system 410 may include a third conduit 412c with a port disposed therein. The combined pump/generator housing 406, which includes a pump (or pump assembly) and a generator (or generator assembly), may include a housing port that is coupled to the port of the third conduit 412c. However, in some variations, the combined pump/generator housing 406 is disposed through a wall of third conduit 412c—e.g., through the port of the third conduit 412c-such that the housing port resides in the third conduit 412c. An example of such a configuration is shown in the rightmost illustration of FIG. 8. Although FIGS. 2A-2B and 4A illustrate only a single housing (or a single combined pump/generator housing), multiple housings and respective first and second flow paths are possible.

In some implementations, the conduit system 222 includes a portion that provides fluid communication between adjacent fluid chambers 214 or subgroups of fluid chambers 214. For example, FIG. 5 presents a schematic diagram, in perspective view, of an example system 500 that includes a hexagonal array of domed walls 502 extending from a base 504. Three domed walls 502 have been omitted in FIG. 5 to provide visibility to a conduit system 506 of the base 504. The hexagonal array of domed walls 502 defines, with the base 504, an inner ring of fluid chambers 508 nested within an outer ring of fluid chamber 510. The conduit system 506 includes individual conduits 512 providing fluid communication between adjacent fluid chambers of the hexagonal array. A first type of individual conduit 512a may provide fluid communication between fluid chambers within a ring, such as the outer ring of fluid chambers 510. A second type of individual conduit 512b may provide fluid communication between fluid chambers of differing rings, such as between the inner and outer rings of fluid chambers 508, 510. The example system 500 of FIG. 5 also includes an access lid or hatch 514 for each of the hexagonal array of domed walls 502. The access lid or hatch 514 may allow selective access to an interior volume of an associated fluid chamber, such as may be required for maintenance or repair. The access lid or hatch 514 may also ease manufacturing of the domed walls 502, for example, by removing an overhang portion that would be necessary to complete a spherical cap shape of the domed walls 502.

Now referring back to FIGS. 2A-2B, the example system 200 may include an anchor 206 configured to couple the base 202 to the underwater floor. The anchor 206 may be operable to provide an additional downward force onto the example system 200 to counteract buoyant forces, such as when the fluid chambers 214 are empty. In some variations, the anchor 206 is configured to penetrate into the underwater floor. In these variations, the base 202 may include a mount (e.g., a through hole in the base 202) for selectively attaching and detaching the anchor 206 from the base 202. In some variations, the anchor 206 may be a suction pile. The suction pile may be part of the base 202 or may be selectively attachable or detachable from the base 202.

In some implementations, the base 202 includes a buoyancy chamber. For example, the example system 400 illustrated by FIGS. 4A-4B includes a base 414 having a plurality of buoyancy chambers 416 distinct from the fluid chambers 408. The plurality of buoyancy chambers 416 may be integral to the base 414 and may include respective ports to receive and discharge fluid (e.g., water, air, etc.). The plurality of buoyancy chambers 416 may aid in transport, installation, and retrieval of the example system 400 to or from a target location. In particular, the plurality of buoyancy chambers 416 may be emptied of water during towing, then filled with water through their respective ports to submerge the example system 400 during installation. During operation of the example system 400, the plurality of buoyancy chambers 416 may remain filled with water to provide mass and thereby aid in securing the example system 400 to the underwater floor. The plurality of buoyancy chambers 416 may also allow a greater percentage of the volume (in some cases, the full volume) of the fluid chambers 408 to be used for energy storage by pumping nearly all the water out, thereby increasing the energy storage capacity of the fluid chambers 408. In some cases, the plurality of buoyancy chambers 416 can be made less expensively than the fluid chambers 408 since they are not repeatedly cycled with water during energy storage like the fluid chambers 408.

In some implementations, the base 202 includes a pocket configured to hold ballast material. The pocket has an opening accessible from an exterior of the base 202 (or an exterior of the example system 200). The ballast material, when present, may provide mass to the example system 400 and thereby aid in securing the example system 400 to the underwater floor.

In some implementations, the example system 200 includes an anchor or ballast material for securing the base 202 to the underwater floor. For example, various types of anchors such as suction buckets, piles, screw anchors, or no anchors (relying on gravity forces) can be used to secure the example system 200 to the underwater floor. Sand or rock ballast materials can be placed in pockets of the base 202 to provide additional low-cost ballast either before transport to the target location or after the example system 200 is installed on the seafloor. In some variations, the base 202 can be configured with a skirt around its perimeter to act as a suction anchor with the underwater floor or to minimize soil scour after installation. The anchors and skirt can optionally be filled with air or balloons during transport to provide additional buoyancy especially for shallow draft ports.

Although FIGS. 2A-2B depict the example system 200 as having three fluid chambers 214, the example system 200 can have two or more fluid chambers 214. In some cases, the fluid chambers 214 (or domed walls 204 associated therewith) may range in size from about 10 meters to 30 meters in diameter for a utility scale system. Smaller fluid chambers 214 may be used, for example, to ease the complexity of manufacturing and improve the logistics of transporting, installing, and retrieving the example system 200. Similarly, the number of anchors 206, inlets, generators, pumps, or buoyancy chambers can be varied from one to a plurality as needed.

In some implementations, the fluid chambers 214 of the example system 200 are arranged in a pattern. For example, the fluid chambers 214 can be arranged in a circular pattern to provide seakeeping stability during towing, installation, and recovery. The circular pattern may also reduce or minimize a quantity of materials used to construct the base 202. Alternatively, fluid chambers 214 can be arranged in an array or matrix pattern such as a rectangle to ease the manufacturing of the base 202. For example, the base 202 may be configured in a linear or rectangular shape similar to a barge. This linear or rectangular shape may allow the base 202 (or example system 200) to fit in ports or dry docks that exist to fabricate and maintain large ships.

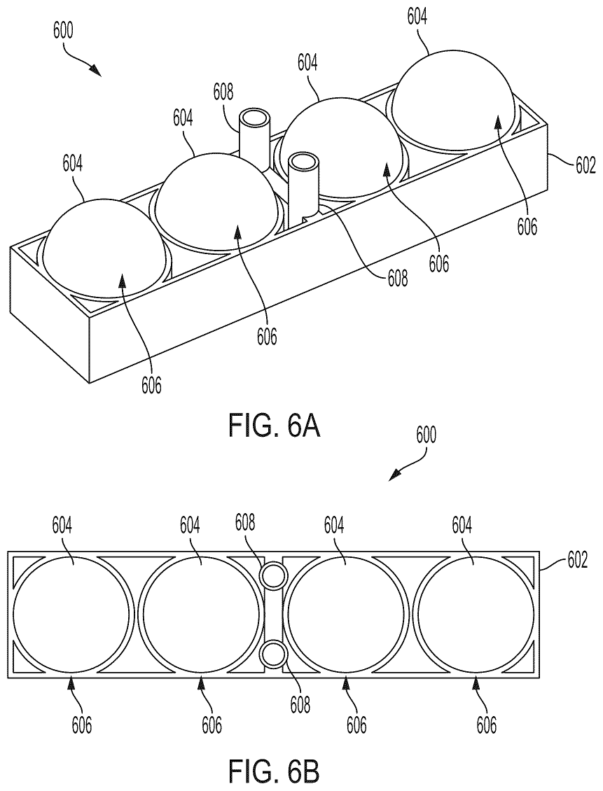

For example, FIGS. 6A and 6B present respective schematic diagrams showing perspective and top views of an example linear-shaped system 600 for storing energy underwater. The example linear-shaped system 600 is analogous to the example system 200 described in relation to FIGS. 2A-2B. The example linear-shaped system 600 includes a linear base 602 and a plurality of domed walls 604 extending therefrom that collectively define a row of fluid chambers 606. The example rectangular-shaped system 600 also includes a plurality of housings 608, each containing a pump and a generator. The plurality of housings 608 are in fluid communication with the row of fluid chambers 606.

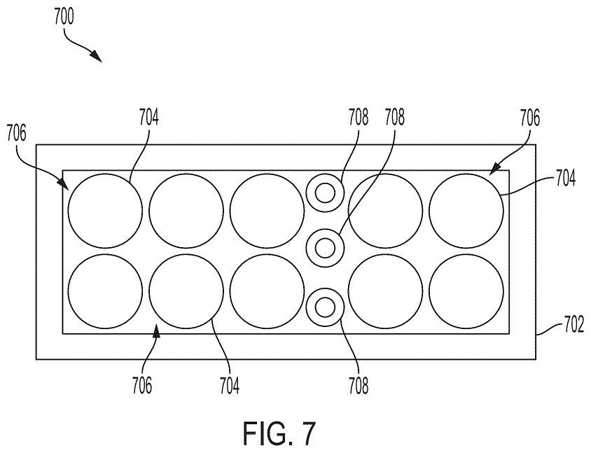

In another example, FIG. 7 presents a schematic diagram, in top view, of an example rectangular-shaped system 700 for storing energy underwater. The example rectangular-shaped system 700 is analogous to the example system 200 described in relation to FIGS. 2A-2B. The example linear-shaped system 700 includes a rectangular base 702 and a plurality of domed walls 704 extending therefrom that collectively define a rectangular array of fluid chambers 706. The example rectangular-shaped system 700 also includes a plurality of housings 708, each containing a pump and a generator. The plurality of housings 708 are in fluid communication with the rectangular array of fluid chambers 706.

In some implementations, the geometry of the domed walls 204 and the base 202 can be varied to change a relative proportion of the base 202 to the plurality of domed walls 204. The relative proportion may be selected to ease manufacturing the base 202 or the plurality of domed walls 204, to alter a buoyancy of the example system 200 for towing in available draft in the port, to achieve improved hydrodynamic stability during towing and installation, to improve a strength of the base 202 by increasing its size, or some combination thereof. For example, the base 202 and the plurality of domed walls 204 may each be associated with about half of the interior volume of the fluid chambers 214. In another example, such as shown in FIGS. 2A-2C, the base 202 and the plurality of domed walls 204 may each be associated with, respectively, about 20% and about 80% of the interior volume of the fluid chambers 214.

In some implementations, the base 202 couples the plurality of domed walls 204 together. The base 202 may also integrate hydraulic ports, provide additional gravitational mass to counteract buoyant forces, include buoyancy chambers that are independent of the fluid chambers 214, and act as a barge for floatation in shallow draft ports.

In some implementations, the base 202 may include a mechanical interface for coupling to the base of another system 200. For example, FIG. 2C presents a schematic diagram, in perspective view, of two instances 200a, 200b of the example system 200 of FIG. 2A coupled to each other through respective mechanical interfaces 226a, 226b. The mechanical interfaces 226a, 226b may include respective surfaces (e.g., flat surfaces) capable of mating with each other. One or both of the two instances 200a, 200b may include a means for selectively coupling the two instances 200a, 200b to each other. For example, a clamp may be configured to secure the mechanical interface 226a of the first instance 200a against the mechanical interface 226b of the second instance 200b. In another example, the mechanical interfaces 226a, 226b may each include a through-hole in a wall of their base. The through-holes may be positioned to align and define a continuous passage when the mechanical interfaces 226a, 226b engage each other. A threaded bolt may be disposed through the passage to secure-in conjunction with a nut and washer—the mechanical interface 226a of the first instance 200a against the mechanical interface 226b of the second instance 200b.

Each of the two instances 200a, 200b may utilize a single generator/pump assembly in a housing (e.g., respective housings 216a, 216b) to service multiple fluid chambers 214. This configuration may reduce the manufacturing cost of each instance 200a, 200b, a considerable portion of which, is anticipated to result from the pump and the generator. The configuration may also improve a reliability of the instances 200a, 200b by reducing a number of parts and possible failure modes. Limiting the number of fluid chambers 214 in each instance 200a, 200b to a small number (e.g., less than 6) can keep the base 202 small enough that an instance can be manufactured in one piece using large scale 3D concrete printing equipment. The instances 200a, 200b can also be manufactured and serviced using existing port facilities (e.g., dry docks) and equipment due to its smaller size. An instance with only one or two fluid chambers 214 may also be a desirable configuration. However, the triangular shape of an instance using three fluid chambers 214 may provide more seakeeping stability and control during towing and deployment.

The example system 200 can be deployed as a stand-alone, long-term energy storage system to complement onshore sources of energy generation, such as onshore wind, solar, fossil fuel electrical generation, or be synergistically integrated with offshore wind, offshore solar, or wave energy deployments. In the latter case, the example system 200 may further reduce the capital and operational costs of the integrated deployment by sharing controls, electrical cables, maintenance equipment, and so forth. The example system 200 can be deployed without being coupled to a tether, for example, not used as an anchor for a floating wind turbine. In some cases, the example system 200 may be electrically coupled to only a transformer station.

In some implementations, the example system 200 includes an electrical cable that communicates electrical power between an onshore electrical system and one or both of the pump and the generator. FIG. 1 presents an example of such a configuration in its rightmost illustration. In some implementations, the example system 200 includes an electrical cable that communicates electrical power between an offshore platform and one or both of the pump and the generator. FIG. 1 presents an example of such a configuration in its middle and leftmost illustrations. In some implementations, the example system 200 includes an electrical cable that communicates electrical power between a transformer and one or both of the pump and the generator. In these configurations, the transformer may operate to transform a voltage, a current, or a phase of electrical energy supplied to or received from the pump or the generator. For example, the transformer may step up or step down an input voltage to supply an output voltage to the pump. As another example, the transformer may step up or step down an input voltage received from the generator to provide an output voltage. In some implementations, the transformer is electrically coupled to a source of electrical energy (e.g., a solar panel, a wind turbine, a natural gas turbine, a wave energy device, etc.) or an electrical load (e.g., an electrical grid for utility service, an industrial plant, etc.). Other types of electrical connections are possible.

Now referring to FIG. 8, a schematic diagram is presented, in cross-section, of an example pump assembly 800, an example generator assembly 802, and an example combined pump/generator assembly 804 for an underwater energy storage system. The example pump assembly 800, the example generator assembly 802, and the example combined pump/generator assembly 804 are contained in respective tubular housings, each of which having first and second ends. The first ends are disposed in a conduit of a conduit system and the second ends are exposed to an exterior environment (e.g., an underwater environment). The first ends have respective first openings that allow an exchange of fluid with the conduit system, and the second ends have openings that allow an exchange of fluid with the exterior environment. A debris screen covers each of the second openings to prevent debris or unwanted objects from entering the tubular housings. In some variations, the tubular housings may include one or more valves to control a flow of water therethrough (e.g., control magnitude of flow, a direction of flow, etc.).

The example pump assembly 800, which may include a turbine, is configured to allow a flow of fluid (e.g., water) from the conduit system to the exterior environment. When the pump of the example pump assembly 800 operates to transport fluid from the conduit system to the exterior environment—e.g., transport water against a hydrostatic pressure of the exterior environment—the pump may operate to store energy. Conversely, the example generator assembly 802, which may also include a turbine, is configured to allow a flow of fluid (e.g., water) from the conduit system to the exterior environment. When the generator of the example generator assembly 802 moves (e.g., rotates) in response to fluid moving from the exterior environment to the conduit system—e.g., water driven by action of the hydrostatic pressure of the exterior environment—the generator may operate to produce electrical energy. The example combined pump/generator assembly 804 is configured to allow a flow of fluid (e.g., water) bi-directionally between the conduit system and the exterior environment. The pump and the generator of the example combined pump/generator assembly 804 may operate analogously to, respectively, the pump of the example pump assembly 800 and the generator of the example generator assembly 802. In some variations, the pump and the generator of the example combined pump/generator assembly 804 may be coupled to each other, such as through one or more gears or a shaft shared in common. The combined pump/generator assembly 804 may include a turbine, such as a turbine shared in common by the pump and the generator.

In certain cases, the components of the example system 200—e.g., the base 202, the plurality of domed walls 204, the anchor 206, the housing 216, and so forth—can be manufactured using additive manufacturing methods, such as automated 3D concrete printing or spray methods. These methods may reduce the manufacturing cost and footprint, increase production rates, and improve worker safety. In some instances, the methods may include conventional processes such as casting of concrete materials or incorporating steel components or reinforcement. In some implementations, one or more of the plurality of domed walls 204 are formed at least in part of hardened layers of cementitious material deposited successively on top of each other (e.g., by printing, spray, etc.). In some implementations, the base is formed at least in part of hardened layers of cementitious material deposited successively on top of each other e.g., by printing, spray, etc.).

Several methods exist for manufacturing, transporting, launching, and recovering an MPH system (e.g., the example system 200 of FIG. 2) from an installation site. The methods can be used in various combinations depending on the available facilities, resources, equipment, and system requirements. In some implementations, the methods include using 3D concrete printing and automated concrete spraying to fabricate the MPH system on a low cost barge located next to a quay. The completed MPH system is then transported on the barge to deeper water near the installation site for launching and installation. A multipurpose semi-submersible may be used to lift the MPH system from the barge and lower it to the underwater floor (e.g., a seabed) for installation. The process may be reversed for recovery, operations and maintenance, or decommissioning.

In some implementations, the methods include the use of concrete printing and concrete spraying to manufacture the MPH system. The methods may also include manufacturing the MPH system on a floating platform. In some implementations, the methods include using a multi-purpose floating platform to lift the MPH system from a barge. The methods may also include using the multi-purpose floating platform to transport or position the MPH system for installation and recovery. The methods may additionally include using the multi-purpose floating platform transport to lower or raise the MPH to or from the underwater floor.

Several methods of manufacturing can be used to fabricate the cementitious components of the MPH system, such as concrete casting, 3D Concrete Printing (3DCP), concrete spraying, or some combination thereof. The methods may be used to fabricate portions of the MPH structure or the entire structure. In some implementations, the methods include 3D printing concrete to fabricate one or more walls of a domed structure and a base followed by spraying of concrete onto the walls. The 3DCP-fabricated wall may form a type of stay-in-place formwork onto which additional concrete materials can be sprayed using a manual or automated concrete spraying system (e.g., in a shotcrete deposition). As such, the methods may quickly create a highly consolidated, high strength bond with the 3DCP formwork and reinforcement materials. The shotcrete materials can be sprayed on an interior or exterior of the stay-in-place formwork or on both sides using a manual or automated process.

Spraying of concrete, sometimes referred to as shotcrete deposition or a shotcrete process, may include applying projected concrete at high velocity primarily onto a vertical or overhead surface. The impact created by the deposition consolidates the concrete. Although the hardened properties of shotcrete concrete are similar to those of conventional cast-in-place concrete, the nature of the deposition process results in an excellent bond with most substrates. The shotcrete process also allows for rapid or instant fabrication capabilities, particularly with complex forms or shapes. The shotcrete process can require less formwork and can be more economical than conventionally placed concrete. Shotcrete cementitious material may be applied using a wet-mix or dry-mix shotcrete process. The wet-mix shotcrete process mixes all ingredients, including water, before introduction into the delivery hose. The dry-mix shotcrete process adds water to the mix at the nozzle. Shotcrete deposition can be used in new construction or repairs of existing construction, and is suitable for curved and thin elements.

In some implementations, the sprayed, printed, and cast cementitious materials incorporate aggregates and various reinforcement materials. These materials may also use binders such as Portland cement or geopolymer cement. Fibrous reinforcement materials such as basalt, polymer, glass, carbon, or steel fibers can be mixed and applied during the printing or spraying process to increase the strength of the hardened concrete body. The fibrous reinforcement materials may also help mitigate shrinkage effects during hardening and curing. Meshes and cable reinforcement can also be incorporated into the 3D printing process. In some instances, the meshes and cable reinforcement may also be applied between applications of printing or spraying.

In some implementations, the 3DCP process can be used to incorporate features such as channels, guide holes, or shelves into the stay-in-place formwork that facilitate the placement and positioning of reinforcement materials (e.g., rebar, post tensioning cables, etc.). The features may also allow for the placement and positioning of MPH system components, such as valves, pipes, screens, flanges in the formwork, and so forth. The MPH system components can be bonded to the existing cementitious materials or to other components using additional materials applied with 3DCP, shotcrete, casting, or grouting, such as shown in FIG. 9. For example, during an initial stage of the 3DCP process, such as shown in the leftmost illustration of FIG. 9, an inner wall of a dome is formed by successively depositing layers of cementitious material on top of each other (e.g., by 3D concrete printing). Geometric features such as grooves or tabs for locating reinforcement materials can be formed at this stage as the inner wall is being formed. During a subsequent stage of the 3DCP process, such as shown in the middle illustration of FIG. 9, reinforcement materials such as rebar are positioned on the inner wall. During a final stage of the 3DCP process, such as shown in the rightmost illustration of FIG. 9, deposition of the layers of cementitious materials continues, thereby covering or embedding the reinforcement materials in the inner wall. For example, the cementitious materials may be sprayed on the reinforcement materials and inner wall. The sprayed cementitious material bonds the reinforcement materials to the inner wall and protects the reinforcement materials from corrosive chemical attack (e.g., from a marine environment).

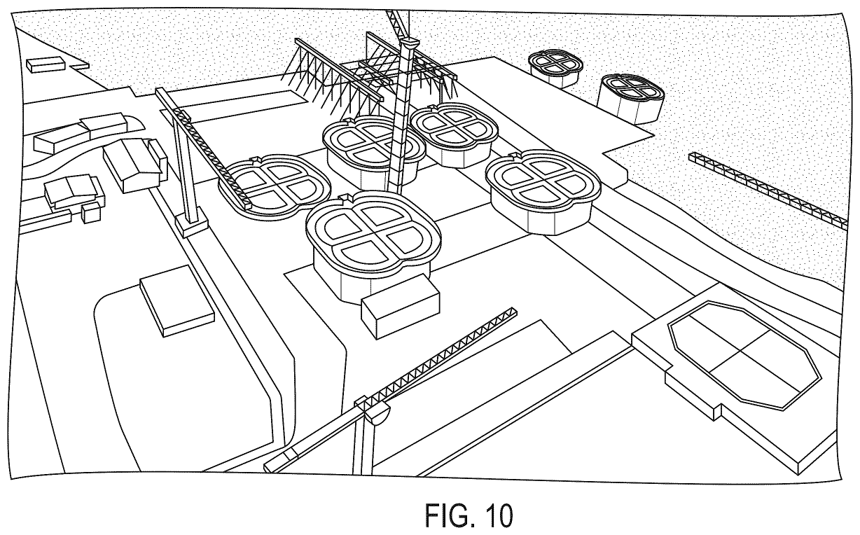

In some implementations, the MPH system is manufactured onshore, such as on a quay. Components for the MPH system may be transferred directly into the water from the quay using heavy lifting equipment (e.g., crane). The components may also be loaded onto a floating platform or vessel using a rail and jacking system designed for moving heavy lifting equipment, such as shown in FIG. 10.

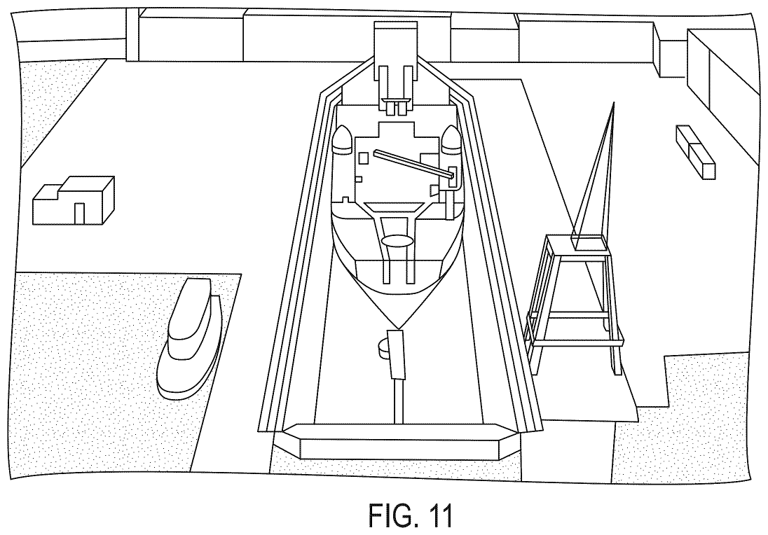

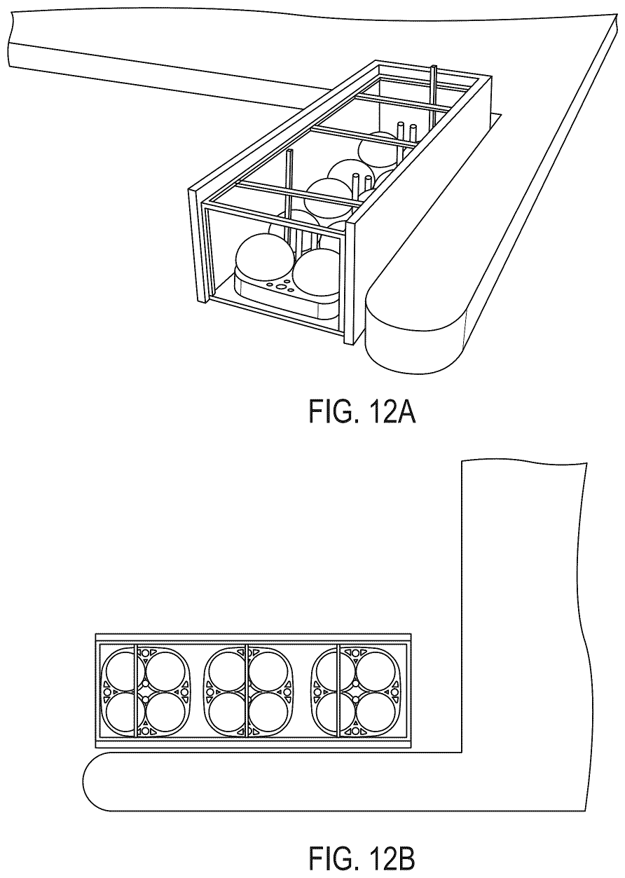

In some implementations, the MPH system is manufactured in a graving dry dock. FIG. 11 presents a schematic diagram of an example graving dry dock. The graving dry dock may be a dock used for ship construction (or repair) that is constructed on land adjacent to water. The graving dry dock may have a rectangular shape with a gate to control water flow. Manufacturing of the MPH system can occur in the graving dry dock with the gate closed and water pumped out. After manufacture of the MPH system is complete, water can be pumped into the graving dry dock, the MPH system floated, and the gates opened to allow the MPH system to be floated and wet towed to the installation site.

In some implementations, the MPH system is manufactured on a floating platform. Onshore construction plants and graving docks of sufficient size, capacities, and numbers for the mass manufacturing of MPH systems may often be unavailable in many desired locations. Moreover, onshore construction sites may require expensive lifting equipment or may be located in ports that are potentially too shallow to wet-tow a larger MPH system. These challenges can be overcome by manufacturing the MPH system on a floating platform such as a barge, a floating dry dock, or a vessel next to a quay. The floating platform can be positioned alongside a quay to facilitate the transfer of materials and labor to the floating platform, as needed, to manufacture the MPH system.

FIG. 12A presents a schematic diagram, shown in perspective view, of an example dry-dock floating platform that is stationed at a dock and contains multiple MPH systems therein. The example dry-dock floating platform includes an additive manufacturing system (e.g., a 3D printing or spray system), which is represented by a framed structure in FIG. 12A. The additive manufacturing system may be used to manufacture the MPH systems, such as by successively depositing layers of cementitious material on top of each other (e.g., by printing, spraying, etc.). The MPH systems may be in the process of being manufactured. FIG. 12B presents a schematic diagram, in top view, of the example dry-dock floating platform of FIG. 12A.

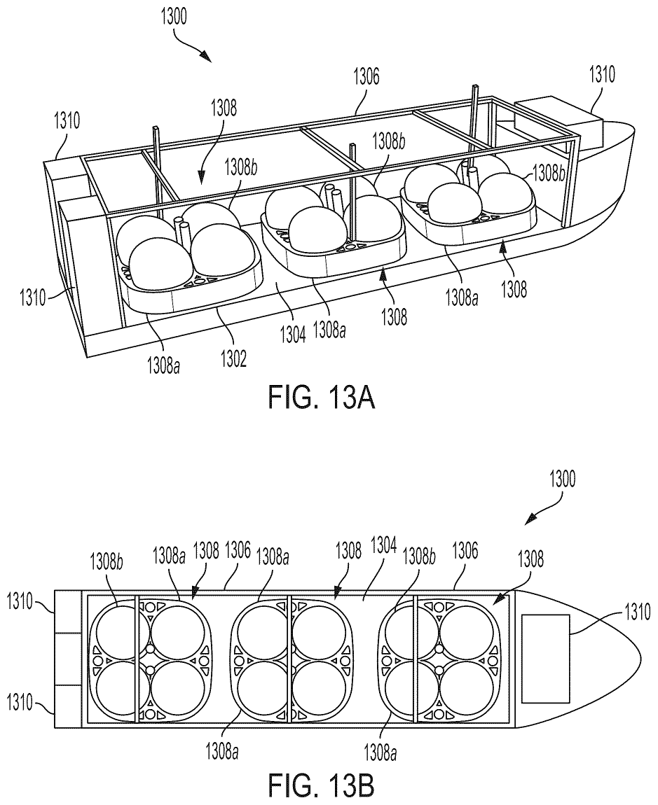

FIG. 13A presents a schematic diagram, in perspective view, of the example submersible barge located on a body of water. The example submersible barge, which corresponds to a floating platform, may be transporting the MPH systems over the body of water or be positioned to install the MPH systems at a target location under the body of water (e.g., the underwater floor). FIG. 13B presents a schematic diagram, in top view, of the example submersible barge of FIG. 13A. The example submersible barge includes an additive manufacturing system (e.g., a 3D printing or spray system), which is represented by a framed structure in FIGS. 13A-13B. The additive manufacturing system may be used to manufacture the MPH systems, such as by successively depositing layers of cementitious material on top of each other (e.g., by printing, spraying, etc.).

In some variations, the floating platforms may include equipment for the 3D printing and spraying of cementitious materials. The equipment may be part of one or more automated manufacturing systems. The 3D printing and concrete spraying process may eliminate removeable formwork, thereby reducing the work area required for manufacturing an MPH system on the floating platform. Moreover, automated manufacturing systems (e.g., 3D printers, 3D shotcrete systems, and reinforcement systems) may allow several floating platforms and manufacturing systems to be used simultaneously, thereby increasing production rates. Furthermore, the automated manufacturing systems and other necessary equipment (e.g., such as material delivery and hoisting equipment) can be placed on the floating platform to create a mobile factory capable of being used at and moved to different ports.

Certain configurations of an MPH system may include massive structures that make transporting, launching, and recovering the MPH system challenging. For example, an MPH system based on four storage spheres and designed for utility-scale grid storage could weigh on the order of 100,000 tons. Such weight is more than most onshore crane systems can lift, and the corresponding size can prevent transportation over roads. In some aspects of what is described here, a method for transporting an MPH system may include a wet tow process, a deck carry process, or both. Wet towing or deck carrying (e.g., such as with a submersible vessel) can also be used to help launch and recover the MPH system at the installation site.

At the installation site, buoyancy chambers in the MPH system can be filled with water to lower the MPH system to an underwater floor in a controlled fashion. Alternatively, lifting equipment can be used to lower the MPH system to the underwater floor. After the MPH system reaches the underwater floor, a variety of anchoring mechanisms, such as screw anchors or suction anchors (or suction piles), can be embedded into the seafloor to secure the MPH system to the underwater floor, if desired. Alternatively, the MPH system can be fastened to a preinstalled foundation system already anchored to the underwater floor. The use of a preinstalled foundation system may allow faster installation and retrieval of the MPH system for maintenance purposes. The lowering process can be reversed for recovery of the MPH system.

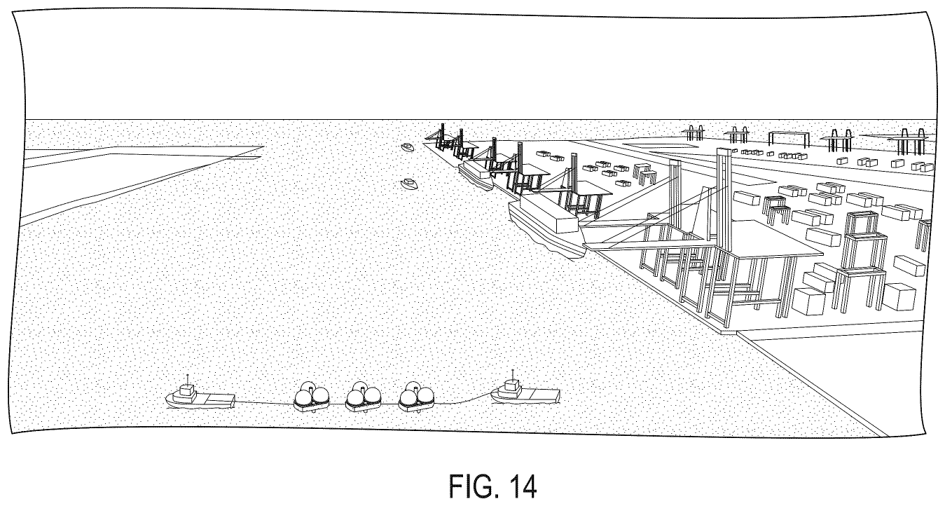

In some implementations, the method for transporting the MPH system includes a wet tow process. In these implementations, the MPH system may be designed with sufficient buoyancy and sea-keeping ability that it can be floated and wet-towed to a desired location. For example, the MPH system may be floated and wet-towed from a manufacturing site to an intermediate site (e.g., a wet storage site) or to an installation site. FIG. 14 presents a schematic diagram of an example wet-tow process that includes multiple MPH systems being towed by tugboats on the surface of a body of water.

Supplemental buoyancy systems can be used to provide additional buoyancy during wet-towing, installation, or retrieval if desired by attaching them to the MPH system. In some variations, one or more buoyancy chambers are integrated into the MPH system, such as shown in FIGS. 4A-4B. Alternatively, a floating crane can be used to perform or assist in the lowering (or raising) of the MPH system to the underwater floor. However, in some cases, wet towing may require a graving dock or large onshore construction crane to move the MPH system into or from the water. Moreover, the water at some ports may lack sufficient depth to float a large utility scale MPH system and the wet-towing process can make sea-keeping challenging in rough seas.

In some implementations, the method for transporting the MPH system includes a deck carry process. In these implementations, the MPH system may be manufactured on or loaded onto a floating platform, such as a floating dry dock, submersible heavy-lift vessel, submersible barge, or non-submersible barge. The MPH system may then be transported on the deck to the installation site. Submersible floating platforms-such as floating dry docks, submersible barges, and submersible heavy lift vessels-can transport launch, and recover the MPH system because these platforms can submerge sufficiently to float the MPH system off or on a support surface (e.g., a deck, an underwater floor, etc.) for installation or recovery. These submersible structures can be built in various sizes and be positioned beside a dock for easy transfer of labor and materials. The submersible structures can also be floated to deeper waters for unloading deep draft structures. Standard non-submersible barges and vessels will require an additional lifting system for launching and recovery, such as a floating crane.

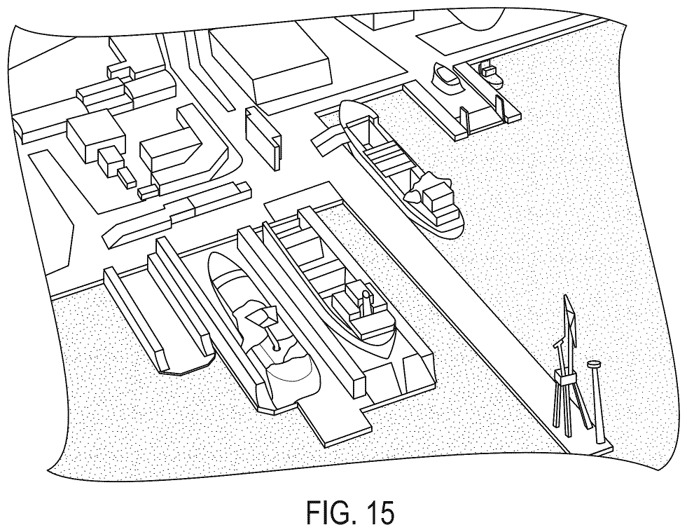

In some implementations, an MPH system is manufactured on a floating dry dock, submersible vessel or platform, such as shown in FIGS. 12A-12B. A floating dry dock is similar to a graving dry dock but is a floatable structure having the cross-sectional form of a “U” structure. FIG. 15 presents a schematic diagram of an example floating dry dock. The floating dry dock may contain a system of valves and buoyancy chambers in its walls and floors that can be opened to fill up with water. These features allow the floating dry dock to raise or lower. Once the MPH system is ready for launching, the floating vessel, platform, or drydock is ballasted to fill the chambers with water allowing it to submerge. The MPH system may then be floated out of the dock or away from the vessel. If the draft of the MPH system is too deep for a port, the dry dock can be floated to deeper water before ballasting the systems and launching the MPH system.

Now referring to FIGS. 13A-13B, an example submersible barge 1300 includes a deck 1302 having a support surface 1304. The example submersible barge 1300 also includes an additive manufacturing system 1306 configured to fabricate a cementitious body 1308 on the support surface 1304, such as by successively depositing layers of flowable cementitious material on top of each other. The cementitious body 1308 may correspond to a base 1308a or a domed wall 1308b of an MPH system, such as described in relation to FIGS. 1 and 2A-2B. However, other types of cementitious bodies are possible (e.g., foundations for wind turbines). In some instances, the additive manufacturing system 1306 is adjacent to the deck 1302. For example, the additive manufacturing system 1306 may be coupled to the deck 1302 and extend over the support surface 1304, as shown in FIGS. 13A-13B. As another example, the additive manufacturing system 1306 may reside adjacent a side of the deck 1302 that is part of its perimeter. In these cases, the additive manufacturing system 1306 may be configured to selectively extend over and retract from the support surface 1304 of the deck 1302 (e.g., by operation of a robotic arm that is part of the additive manufacturing system 1306).

The example submersible barge 1300 additionally includes a buoyancy system 1310 configured to lower the cementitious body 1308 into a body of water by altering a draft of the example submersible barge 1300. The draft of the example submersible barge 1300 may, for example, correspond to a depth of the example submersible barge 1300 below the surface of the body of water. In some instances, the buoyancy system 1301 may be configured to alter the draft between a first draft, where the support surface 1304 resides above a surface of a body of water, and a second draft, where the support surface 1304 resides below the surface of the body of water. However, other draft positions are possible. In some implementations, the example submersible barge 1300 includes a hoisting system adjacent to the deck 1302 and configured to lift the cementitious body 1308, when fabricated, from the support surface 1304. The hoisting system may, for example, reside adjacent a side of the deck 1302. However, other positions are possible.

In some implementations, the additive manufacturing system 1306 includes a 3D printer that successively prints layers of flowable cementitious material on top of each other. In some implementations, the additive manufacturing system 1306 includes a spraying system that successively sprays layers of flowable cementitious material on top of each other. In certain configurations of the additive manufacturing system 1306, the spraying system and the 3D printer are both part of the additive manufacturing system 1306.

The additive manufacturing system 1306 may include other equipment or systems to help fabricate the cementitious body 1308. For example, the additive manufacturing system 1306 may include a mixer that mixes fibrous reinforcement materials into the flowable cementitious material. As another example, the additive manufacturing system 1306 may include an assembly system (e.g., one or more robotic arms) that assembles mesh or cable reinforcement into a support structure that receives the successively deposited layers of flowable cementitious material.

During operation, the example submersible barge 1300 may utilize the additive manufacturing system 1306 to deposit successive layers of flowable cementitious material on top of each other to form the cementitious body 1308 (e.g., by 3D printing, spray, etc.). The additive manufacturing system 1306 may also mix fibrous reinforcement materials into the flowable cementitious material by operation of the mixer, if present. In some implementations, the additive manufacturing system 1306 may assemble mesh or cable reinforcement into a support structure that receives the successively deposited layers of flowable cementitious material. Such assembly may occur before the flowable cementitious material is deposited. The cementitious body 1308 resides on the support surface 1304 during fabrication, and the flowable cementitious material hardens into a solidified cementitious material.

After fabrication, the example submersible barge 1300 can be used to transport the cementitious body 1308 to a target location on the body of water. Upon reaching the target location, the example submersible barge 1300 may utilize the buoyancy system 1310 to lower the cementitious body 1308 into the body of water. During such lowering, the buoyancy system 1310 may alter the draft of the example submersible barge 1300 to the second draft (e.g., from the first draft to the second draft).

In certain cases, the example submersible barge 1300 may be used to retrieve the cementitious body 1308. In these cases, the example submersible barge 1300 may move to a retrieval location on the body of water where the cementitious body 1308 is to be loaded onto the deck 1302. Upon reaching the retrieval location, the buoyancy system 1310 may alter the draft of the example submersible barge 1300 to the second draft, thereby lowering the support surface 1304 below the surface of the body of water. The second draft may allow the cementitious body 1308 to be loaded on the deck 1302 (e.g., by allowing the cementitious body 1308 to float onto the support surface 1304). In some implementations, the hoisting system (if present) may be used to lift or pull the cementitious body 1308 onto the support surface 1304. The buoyancy system 1310 then alters the draft of the example submersible barge 1300 to the first draft. When loaded on deck 1302, the cementitious body 1308 may be inspected or repaired. However, the example submersible barge 1300 may also transport the cementitious body 1308 over the body of water to another location, such as a port or quay.

Several methods of manufacturing may be used to manufacture the cementitious components of an MPH system. For example, the cementitious components can be manufactured using concrete casting, 3D concrete printing, concrete spraying, or combinations thereof. These methods can be used for portions of an MPH structure (e.g., one or more components thereof) or the entire structure. In many cases, 3D concrete printing may be used to fabricate one or more walls of a hemispherical upper structure or a base component followed by the spraying of cementitious material (e.g., concrete in fluid, unhardened form) onto the wall. The 3D printed wall forms a type of stay-in-place formwork onto which additional cementitious material can be sprayed using, for example, a manual or automated shotcrete spraying system. Such spraying may quickly create a highly consolidated, high strength bond to the 3D concrete printed formwork as well as the reinforcement materials. The cementitious material can be sprayed on the interior or exterior of the stay-in-pace formwork or on both sides using a manual or automated process.

Spraying of concrete is a method of applying fluid, unhardened concrete projected at high velocity primarily on to a vertical or overhead surface, such as shown in the rightmost illustration of FIG. 9. The impact created by the application consolidates the concrete. In many cases, the hardened properties of sprayed concrete are similar to those of conventional cast-in-place concrete. Moreover, the nature of the placement process may result in an excellent bond with most substrates, and rapid or instant capabilities, particularly on complex forms or shapes. The spray process requires less formwork and can be more economical than conventionally placed concrete. Sprayed concrete may be applied using a wet- or dry-mix process. The wet-mix spray process mixes all ingredients, including water, before introduction into the delivery hose. The dry-mix spray process adds water to the mix at the nozzle. Sprayed concrete may be used in new construction and repairs, and in many cases, is suitable for curved and thin elements.

In some implementations, sprayed and printed cementitious materials can incorporate aggregates and various reinforcement materials. The sprayed and printed cementitious material may also use binders such as Portland cement or geopolymer cement. Fibrous reinforcement materials such as basalt, polymer, glass, carbon, or steel fibers can be mixed and applied during the printing or spraying process, such as to increase the strength and help mitigate shrinkage effects during hardening and curing of the components. Meshes and cables can also be incorporated into the 3D printing process or applied between applications of printing or spraying.

In some implementations, the 3D concrete printing process is used to incorporate features such as channels, guide holes, or shelves that facilitate the placement and positioning of reinforcement materials such as rebar or post tensioning cables. The process may also facilitate the placement and positioning of components such as valves, pipes, screens, flanges in the formwork. These components can be bonded to the existing cementitious materials or to other components using subsequent processes such as 3D printing, spraying, or grouting.

In some implementations, the MPH systems are manufactured onshore, such as at quayside or at a graving dock. The MPH systems may then be transferred directly into the water for wet towing, or alternatively, transferred onto a floating platform or vessel. The floating platform or vessel may allow transport of the MPH systems using heavy lifting equipment such as a rail or jacking system designed for moving heavy lift equipment, such as shown in FIG. 10. However, in certain situations, construction plants of sufficient size and capacities for mass manufacturing are unavailable in many locations of where MPH systems desired to be installed. These plants may also entail expensive equipment, and may be located in ports that are potentially too shallow (e.g., typically about 10-m) to wet-tow large MPH systems.

In some implementations, the MPH systems are manufactured on floating platforms. The absence of removeable formwork in the 3D printing and concrete spraying processes reduces the work area required for manufacturing, thereby allowing low-cost manufacturing of one or more MPH systems on floating platforms. Examples of such platforms include barges, floating dry docks, floating shiplifts, or vessels. Automated manufacturing systems (e.g., 3D printers, spray systems, reinforcement systems, etc.) could allow several floating platforms with onboard manufacturing systems to be used simultaneously thus increasing production rate. The 3D printing or spray systems, along with other necessary equipment (e.g., material delivery and hoisting equipment), can be placed on the platforms to form a mobile factory that can be used at various ports. The platforms can also be positioned alongside quays to facilitate the transfer of materials and labor to the floating platform needed to manufacture the MPH system.

In certain configurations, an MPH system may be massive, which makes the method of launching the MPH system critical to its deployment and retrieval. For example, a four-sphere MPH system designed for utility-scale grid storage could weigh on the order of 100,000 tons, which is more than most crane systems can lift. Moreover, the four-sphere MPH system may be too large and heavy to transport over roads. Methods of manufacturing and launching such structures include, for instance, manufacturing and launching in a graving dry dock. Such structures may also be manufactured or launched in or near a floating submersible vessel or platform, such as a floating dry dock, submersible barge, or submersible platform. Alternatively, the MPH system can be manufactured portside and moved onto the floating vessel, dry dock, or barge using rails, jacks, or specialized heavy lift moving equipment. A third option is to construct a specialized water born lifting system such as a multi-purpose submersible vessel (MPSS) that can more efficiently lift the structure from a either a submersible or non-submersible platform. Descriptions of each of these three manufacturing and launching approaches follows.

FIG. 11 presents a schematic diagram of an example graving dry dock. A graving dry dock is normally constructed on land near coastal waters with a rectangular, solid concrete construction using blocks, walls, and gates. Manufacturing of an MPH system in such docks would occur with the gate closed and water pumped out. After manufacturing of the MPH system is complete, water would be pumped into the graving dock, the MPH system floated, and the gates opened to allow the MPH system to be towed to the installation site, as shown in FIG. 14.

FIG. 15 presents a schematic diagram of an example submersible floating platform, and in particular, an example floating dry dock. Submersible floating platforms such as floating dry docks, submersible barges, or submersible vessels can be used to lower an MPH system sufficiently to float for installation or removal. These submersible structures can be built in various sizes and maneuvered beside a dock for easy labor and materials transfer. The submersible structures may also be floated to deeper waters for unloading deep draft structures. A floating dry dock is similar to a graving dry dock but is a floatable structure in the form of “U” structure (see FIG. 15). The floating dry dock may contain a system of valves and buoyancy chambers in its walls and floors that can be opened to fill up with water to raise of lower the dock. The MPH system can be manufactured on floating dry dock, submersible vessel, or platform. FIGS. 12A and 12B present examples of such manufacture. Once the MPH system is ready for launching, the floating vessel, platform, or drydock is ballasted to fill the chambers with water allowing it to submerge. The MPH system can then be floated out of the dock or away from the vessel. If the draft of the MPH system is too deep for a port, the dry dock can be floated to deeper water before ballasting the systems and floating out the MPH system.

In some implementations, the MPH system can be launched and recovered using a multi-purpose submersible vessel (MPSS). In many cases, the MPSS is configured to lift the MPH system from or onto a low-cost, readily available, non-submersible barge. The MPSS may also be configured to recover an MPH system in the event that its buoyancy system is inoperable. The MPSS may additionally be configured to facilitate the installation and recovery of the MPH system during rough seas, thereby simplifying the design of the MPH system's buoyancy and wet towing systems.

The absence of removeable formwork in the 3D printing and concrete spraying processes may reduce the work area required for manufacturing MPH systems, thereby allowing the low-cost manufacturing of one or more MPH systems on readily available, low cost, standard (non-submersible) barges. FIGS. 13A and 13B present schematic diagrams of an example submersible barge that is located on a body of water. The automated nature of the manufacturing systems could allow several barge and printer systems to be used simultaneously to increase production rate. The 3D printing or spray systems, along with other necessary equipment, such as material delivery and hoisting equipment, can be placed permanently or temporarily on the barge to form a mobile factory that can be used at various ports. The barges can be positioned alongside the quay at various ports to facilitate the transfer of materials and labor needed to manufacture the MPH system.

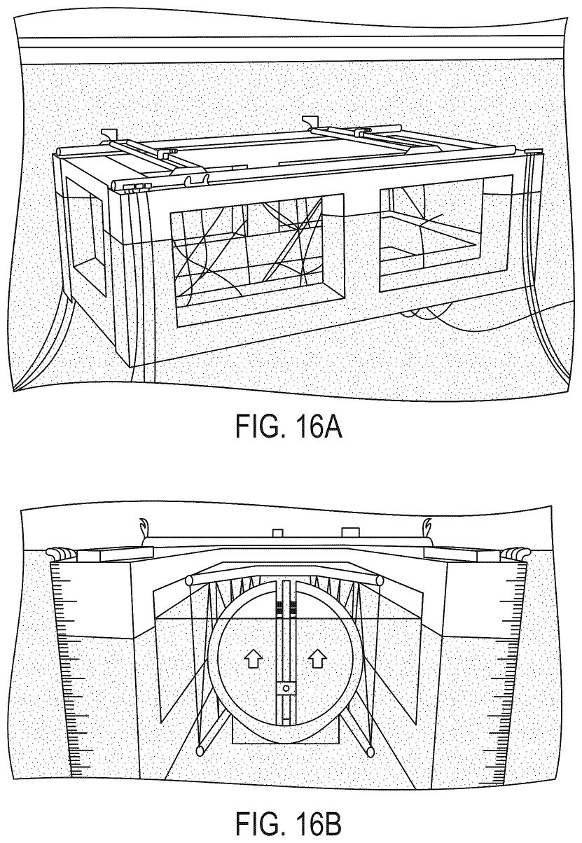

After manufacturing, the barge and MPH system can be floated to deeper water or closer to the installation site for unloading with an MPSS, as shown in FIG. 16B. (FIG. 16A shows the MPSS unladen and floating in a body of water.) The MPSS may be particularly advantageous because, under many conditions, it can be maneuvered over the barge to enable a more efficient lifting of the MPH system from the barge. Such lifting may occur, for example, by using multiple lower cost jacking or winch hoisting systems. The MPSS can lift the MPH system from the deck of the barge and lower it into the water for final transportation to the installation site. Moreover, the MPSS system may be very stable at sea and resist motion due to waves. Such stability and resistance may result from the superior sea-keeping features of the MPSS that result from its large waterplane area yet small exposure to waves.

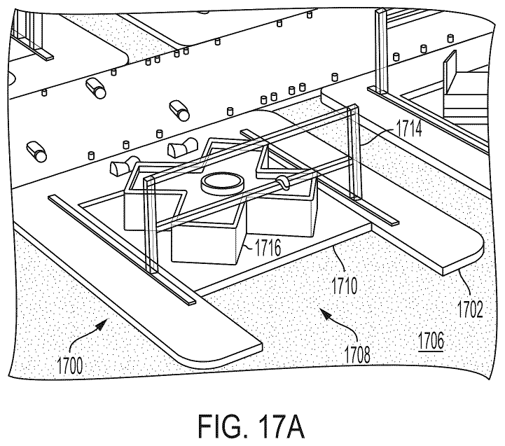

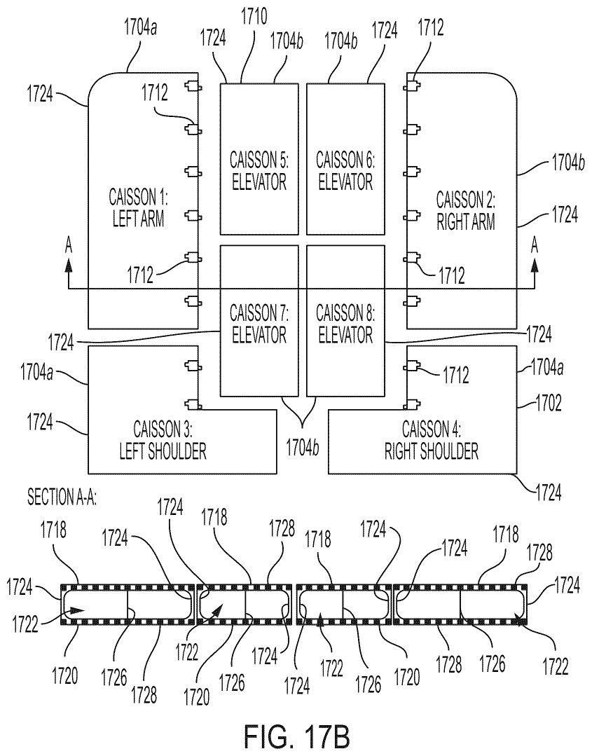

Various installation and recovery methods may be used with an MPH system or a cementitious body (e.g., a wind turbine foundation). For example, a floating wind turbine foundation may be formed of cementitious material and designed to be wet towed to or from the installation site, such as shown in FIG. 17A. FIG. 17A illustrates an example floating shiplift 1700 that includes an elevator 1710. A floating wind-turbine foundation 1716 is being fabricated on the elevator 1710. However, other types of cementitious bodies are possible (e.g., an MPH system). In cases involving an MPH system, the MPH system may use ballast or buoyancy chambers (if present) to lower or raise the MPH system. Moreover, supplemental buoyancy systems can be used to provide additional buoyancy during wet-towing, installation, or retrieval if desired by attaching them the MPH system.

After the MPH system reaches the seafloor, a variety of anchoring mechanisms (e.g., screw anchors, suction anchors, etc.) can be embedded into the seafloor to secure the MPH system to the sea floor if desired. Alternatively, the MPH system can be fastened to a preinstalled foundation system already anchored to the seafloor. The use of a preinstalled foundation system can, in many cases, allow for faster installation and retrieval of the MPH system for maintenance purposes.

In some implementations, the MPH system is manufactured, assembled, launched, and recovered using a floating platform with a shiplift. Submersible vessels, dry docks, and floating shiplifts for manufacturing and assembling large offshore energy structures are particularly useful for offshore energy development. Manufacturing large offshore energy foundations and assembling components on those foundations can require substantial land area and very high-capacity wharves. This combination of features is not available in many ports. Moreover, port infrastructure projects to support the manufacture and assembly of offshore wind turbines are often mega-projects that have high costs, require extensive permitting and environmental reviews, and extend across multiyear timelines (e.g., 10 to 25 years).

An MPH sphere (or other large marine energy component) may therefore be manufactured, assembled, launched and recovered using a method that includes installing a 3D printer or manufacturing system on a floating shiplift (FS). The manufacturing system is positioned over or on the shiplift elevator to manufacture the sphere directly on the elevator. The FS can also be used to assemble components on the MPH sphere without having to move the foundation relative to the elevator. The elevator can then be lowered into to the water to launch the MPH sphere for transport to another site, such as for further assembly operations or for installation. The elevator can also be used to help retrieve the MPH system for maintenance or decommissioning.

The FS can also be used to manufacture other large offshore structures such as offshore wind foundations, offshore solar foundations, wave energy foundations, anchors, seawalls, ship hulls, or floating house foundations. In some implementations, the FS is a versatile, modular, floating concrete dock that supports a variety of equipment to manufacture, launch, and retrieve offshore components such as floating wind turbine foundations. FIGS. 17A-17B present respective schematic diagrams of an example floating shiplift 1700. FIG. 17A illustrates, in perspective view, the example floating shiplift 1700 manufacturing a cementitious body 1716 (e.g., a floating wind-turbine foundation) on its elevator 1710. FIG. 17B illustrates, in top and cross-section views, example configurations for a deck 1702 and elevator 1710 of the example floating shiplift 1700. The scale between FIGS. 17A and 17B may be different. In many implementations, the example floating shiplift 1700 combines a structurally optimized modular floating dock with an integrated heavy ship-lift platform to rapidly manufacture, launch, and retrieve offshore wind foundations (and turbines) in ports. FIG. 17B shows a configuration of the example floating shiplift 1700 that has a capacity of 15,000 tons. However, other capacities are possible.

The example floating shiplift 1700 includes a deck 1702 having deck caissons 1704a that are coupled to each other. The deck caissons 1704a float on a body of water 1706 and are arranged to define a slip 1708 of the deck 1702. FIG. 17B depicts the deck caissons 1704a as configured to define arms and shoulders for the deck 1702. However, other configurations are possible. The example floating shiplift 1700 also includes an elevator 1710 that resides in the slip 1708. The elevator 1710 has elevator caissons 1704b that are coupled to each other. A hoisting system 1712 of the example floating shiplift 1700 couples the elevator 1710 to the deck 1702 and is configured to selectively raise and lower and the elevator 1710 relative to the deck 1702. FIG. 17B depicts the hoisting system 1712 as including a plurality of chain jacks that are disposed around a perimeter of the slip. However, other configurations and componentry are possible for the hoisting system 1712 (e.g., winches, pumps, etc.).

The example floating shiplift 1700 additionally includes an additive manufacturing system 1714 that is configured to fabricate the cementitious body 1716 on the elevator 1710. In FIG. 17A, the cementitious body 1716 is depicted as a floating wind turbine foundation. However, other types of cementitious bodies are possible (e.g., an MPH sphere, a foundation for a wave energy device, a foundation for an offshore solar device, an anchor, a caisson, artificial reefs, etc.) The additive manufacturing system 1714 may include equipment or systems that manipulate flowable cementitious material. For example, the additive manufacturing system 1714 may perform operations that include successively depositing layers of flowable cementitious material on top of each other. To so do, the additive manufacturing system 1714 may include a 3D printing system, a spraying system, a slip-forming system, or a combination thereof. FIG. 17A shows a configuration in which the additive manufacturing system 1714 is coupled to the deck 1702 and extends over the elevator 1710 (e.g., a gantry configuration).

In some implementations, the additive manufacturing system 1714 is disposed on the elevator 1710 and coupled thereto. However, in some implementations, the additive manufacturing system 1714 may have respective portions that are disposed on the deck 1702 and the elevator 1720. For example, the additive manufacturing system 1714 may include a gantry that can traverse back and forth on tracks between the deck 1702 and the elevator 1720. In this configuration, the tracks may each have first and second portions that are disposed on, respectively, the deck 1702 and the elevator 1720. The first portions may, for instance, be configured to allow the gantry structure to be parked on the deck 1702 and off the elevator 1710.

In some implementations, the caissons 1704 may include top and bottom walls 1718, 1720 that are separated by an internal cavity 1722 of the caisson 1704. The bottom wall 1720 is oriented towards the body of water 1706. The caissons 1704 may also include a perimeter wall 1724 that extends between the top and bottom walls 1718, 1720 and defines a perimeter of the caisson 1704. The perimeter wall 1724 surrounds the internal cavity 1722 and, with the top and bottom walls 1718, 1720, may enclose the internal cavity 1722. This enclosure may allow the caissons 1704 to define a hollow structure that, in many cases, is watertight. The caissons 1704 additionally include one or more stiffening walls 1726 in the internal cavity 1722 that extend between the top and bottom walls 1718, 1720. The one or more stiffening walls 1726 may partition the internal cavity 1722 into a plurality of sub-cavities. In some implementations, one or both of the deck caissons 1704a and the elevator caissons 1704b are formed of cementitious material.

In some implementations, the deck and elevator caissons 1704a, 1704b are configured such that the deck 1702 and the elevator 1710 have respective centers of buoyancy that are aligned with each other. This alignment may, for example, result in the centers of gravity being coincident along a direction that is perpendicular to a surface of the body of water 1706.

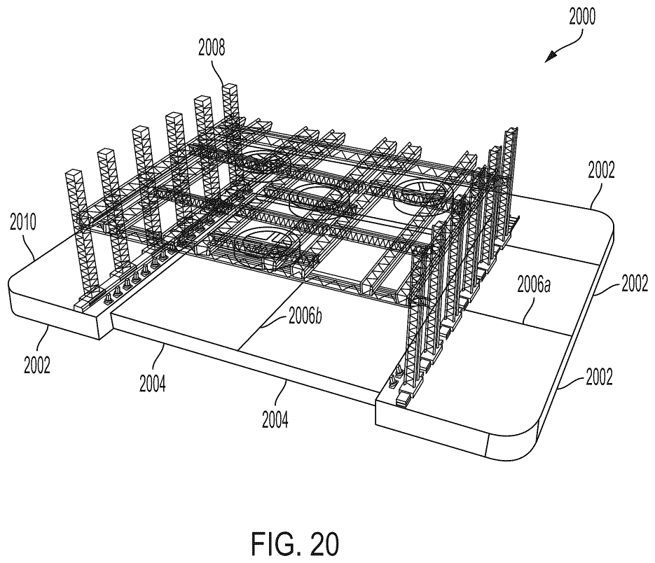

In some implementations, the deck caissons 1704a or the elevator caissons 1704b include first and second caissons that are coupled to each other at a caisson joint. An example of a caisson joint is shown in FIG. 20, which illustrates deck caisson joints 2006a between neighboring pairs of deck caissons 2002 and elevator caisson joints 2006b between neighboring pairs of elevator caissons 2004. In these implementations, a post-tensioning tendon 1728 extends through the first caisson, the caisson joint, and the second caisson. However, other caissons may be included in this extension. For example, the post-tensioning tendon 1728 may extend may through a series of deck caissons 1704a or a series of elevator caissons 1704b (e.g., two caissons, three caissons, four caissons, etc.) to reinforce respectively, the deck 1702 or the elevator 1710 as an entire structure. In some implementations, the deck caissons 1704a or the elevator caissons 1704b include linear caisson joints that are aligned parallel to each other.

In some implementations, at least one elevator caisson 1704b has a buoyancy chamber that comprises one or more sub-cavities of the at least one elevator caisson 1704b. The one or more sub-cavities are in fluid communication with each other. In some implementations, the hoisting system 1712 may include a pump that, during raising or lowering of the elevator 1710, alters an amount of water the buoyancy chamber. The amount of water in the buoyancy chamber acts as a type of ballast that alter a weight of the elevator 1710. In some implementations, the buoyancy chamber includes a port that is configured to receive water into, or discharge water from, the one or more sub-cavities. The pump may displace water through the port to add or remove water from the buoyancy chamber.

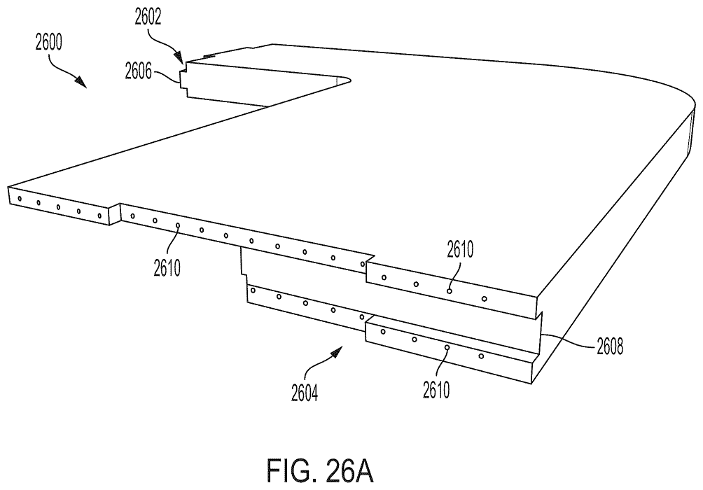

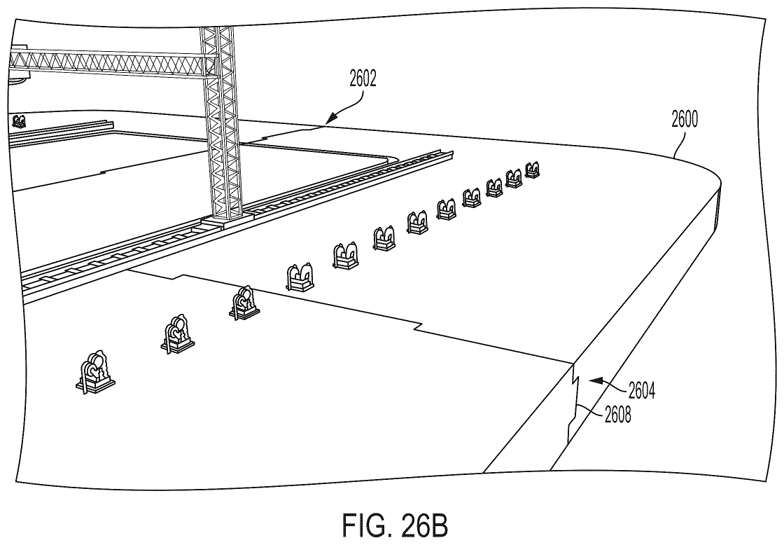

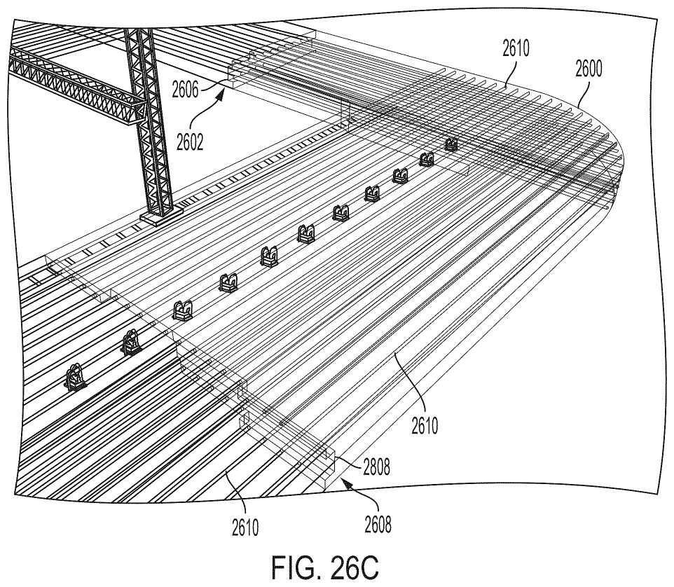

In some implementations, the deck caissons 1704a or the elevator caissons 1704b include a first caisson having a first mechanical interface on a perimeter wall of the first caisson. The deck caissons 1704a or the elevator caissons 1704b may also include a second caisson having a second mechanical interface on the perimeter wall of the second caisson. In these implementations, the first and second mechanical interfaces interlock with each other to couple the first caisson to the second caisson. Examples of such mechanical interfaces are described further in relation to FIGS. 26A-26C.

In some implementations, the top walls 1718 of the deck caissons 1704a include respective top surfaces that are co-planar with each other and define a planar deck surface of the deck 1702. Similarly, the top walls 1718 of the elevator caissons 1704b may include respective top surfaces that are co-planar with each other and define a planar elevator surface of the elevator 1710. These implementations may allow the example floating shiplift 1700 to have a level surface. For example, the hoisting system may be configured to selectively raise and lower and the elevator 1710 between an upper position, where the planar elevator surface is level with the planar deck surface, and a lower position, where the planar elevator surface resides below the surface of the body of water 1706. In certain cases, the lower position of the elevator 1710 may allow the cementitious body 1716, when fabricated, to be submerged (e.g., partially submerged) and subsequently moved off the elevator 1710 into the body of water 1706. The lower position may also allow the cementitious body 1716 or other types of bodies to be loaded onto the elevator from the body of water 1706 (e.g., for inspection, repair, etc.). In certain cases, the elevator 1710 may have an uppermost position where the planar elevator surface resides above the planar deck surface.

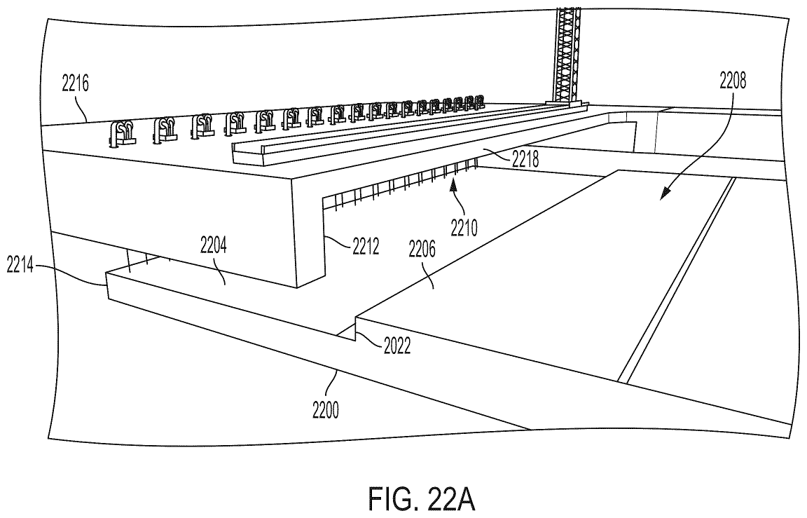

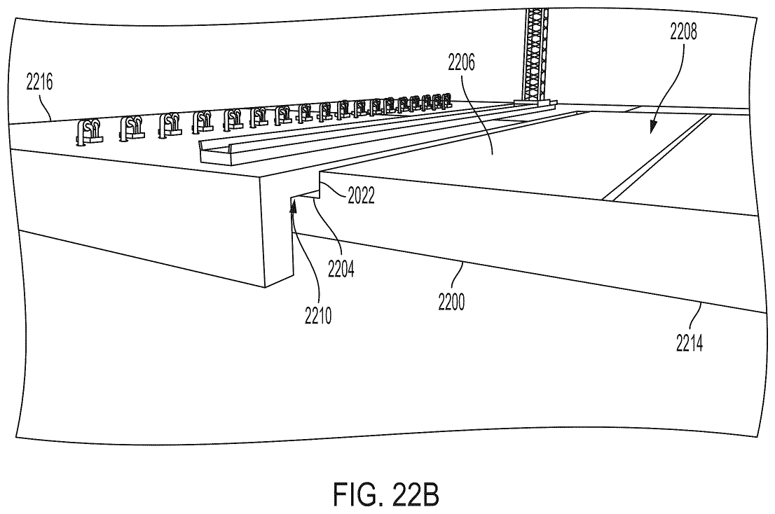

In some implementations, the top wall 1718 of at least one elevator caisson 1704b includes a step that transitions between a lower surface and an upper surface of the top wall 1718. FIG. 22A shows an example elevator caisson 2200 that has a step 2202 between a lower surface 2204 and an upper surface 2206 of its top wall 2208. The lower surface 2204 of the top wall 2208 resides below the bottom walls 2210 of one or more deck caissons 2212. FIG. 22B shows the example elevator caisson 2200 of FIG. 22A but in which the elevator 2214 engages the deck 2216. More specifically, the lower surface 2204 of the top wall 2208 contacts the bottom walls 2210 of the one or more deck caissons 2212. Such contact may result in friction that helps secure the elevator 2214 in place. However, other features may help secure the elevator 2214 in place. For instance, the step 2202 of the top wall 2208 resides adjacent the perimeter walls 2218 of the one or more deck caissons 2212. This neighboring placement may also help to secure the elevator 2214 in place.

Now referring back to FIGS. 17A-17B, the example floating shiplift 1700 may utilize the additive manufacturing system 1714 to fabricate the cementitious body 1716. To do so, the additive manufacturing system 1714 may successively deposit layers of flowable cementitious material on top of each other, such as by printing the layers, spraying the layers, slip-forming the layers, or a combination thereof. To do so, the additive manufacturing system 1714 may include a 3D printer, a spray system, and/or a slip-forming system. For example, the additive manufacturing system 1714 may use the additive printer to successively print layers of flowable cementitious material on top of each other. As another example, the additive manufacturing system 1714 may use the spray system to successively spray layers of flowable cementitious material on top of each other. As yet another example, the additive manufacturing system 1714 may use the slip-forming system to successively slip-form layers of flowable cementitious material on top of each other. Combinations of these operations are possible. In cases where the layers are slip-formed, the slip-formed layers may define respective sections (e.g., cross-sectional portions) of the cementitious body 1716. These sections may be fabricated on top of each other, such as in a continuous series of sections, to successively build the cementitious body 1716 (or a portion thereof).

The flowable cementitious material is allowed to harden into a solidified cementitious material, thereby fabricating the cementitious body 1716. In certain cases, the cementitious body 1716 is part of a larger structure (e.g., a foundation, a caisson, etc.), and as such, the additive manufacturing system 1714 may fabricate a second cementitious body on a surface of the cementitious body 1716.

The additive manufacturing system 1714 may also include equipment and systems to assist with the fabrication of the cementitious body 1716. For example, the additive manufacturing system 1714 may include a mixer that is used to mix fibrous reinforcement materials into the flowable cementitious material. Such mixing may occur before or as part of the deposition process. As another example, the additive manufacturing system 1714 may include an assembly system (e.g., one or more robotic arms). The assembly system may allow the additive manufacturing system 1714 to assemble mesh or cable reinforcement into a support structure that receives the successively deposited layers of flowable cementitious material. The support structure may be incorporated in whole or in part into the cementitious body 1716.

After the cementitious body 1716 is fabricated, the example floating shiplift 1700 may utilize the hoisting system 1712 to lower the elevator 1710 to a lower position where the elevator 1710 resides below the surface of the body of water 1706. If the buoyancy chamber is present, the hoisting system 1712 may activate the pump to fill the buoyancy chamber with water, thereby increasing the weight of the elevator 1710. When the elevator 1710 reaches the lower position, the cementitious body 1716 may be moved off the elevator 1710 into the body of water 1706.

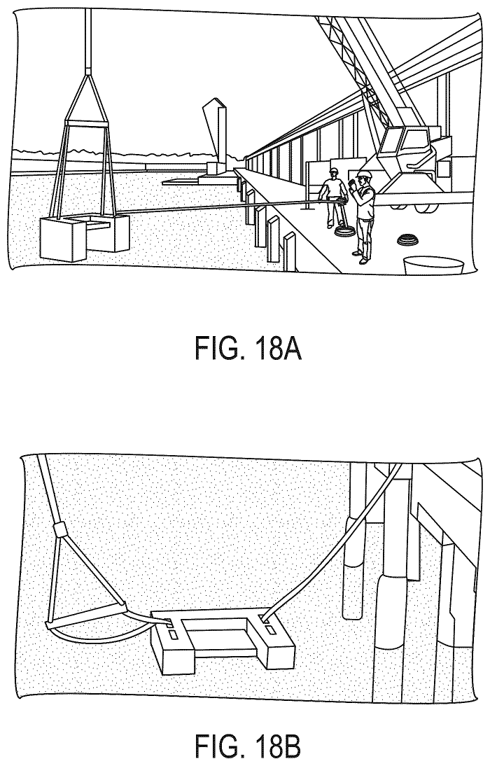

The FS can, in many instances, use a floating platform to sidestep the need for dredging, infilling, and constructing the massive, expensive, environmentally damaging, high-capacity wharves currently needed for constructing and deploying large offshore components. Because the FS floats like a barge, it can be constructed and permitted in a fraction of the time when compared to conventional heavy lift marine terminals/port infrastructure. For example, FIG. 18A presents a schematic diagram of an example floating shiplift that includes a 3D printed concrete body and is being lowered into a body of water adjacent a port. The example floating shiplift is a small-scale configuration that can be fabricated and assembled in about 2 days time and deployed in a marine environment. FIG. 18B presents a schematic diagram of the floating shiplift of FIG. 18A but floating in the body of water.

In some implementations, the FS is configured to support a versatile array of concrete manufacturing techniques directly on the integrated elevator to eliminate heavy-lift/hoisting operations. This includes slip forming, 3D concrete printing (3DCP), casting, and assembly of precast or steel modular components, depending on the floating foundation being manufactured. The FS can allow the assembly and deployment of large offshore structures many years before major port improvement projects (e.g., at least five years). This early assembly and deployment may be achieved by combining multiple FS manufacturing stations with existing lift-boats as part of a component feedering and turbine assembly strategy. In some cases, and in the longer term, the FS can increase the throughput of shore-based marshalling and assembly facilities when they become available by, for example, offloading manufacturing and refurbishment operations from shore-based staging/integration facilities (thereby reducing land use). The FS can also increase throughput of shore-based marshalling and assembly facilities by serving as a launching or retrieval barge for assembled foundations and turbines in place of costly semi-submersible vessels.

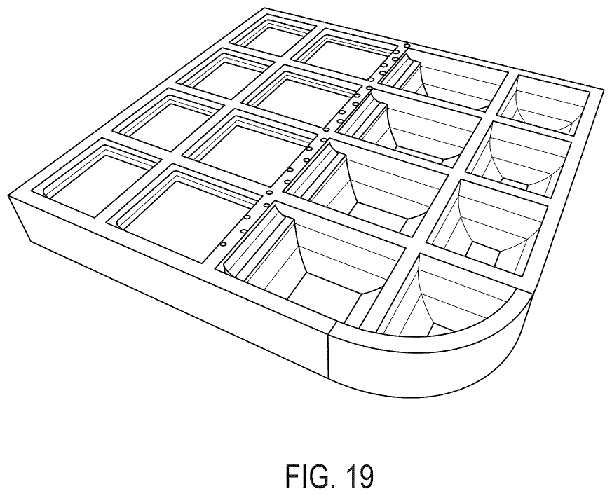

In many implementations, the FS is configured to manufacture, launch, and retrieve concrete floating structures directly on the FS elevator without moving the foundation after manufacture. Such operation may be allowed by one or more features of the FS. For example, the FS may include caissons, such as shown in FIG. 19. The FS may be configured to 3D print the caissons, and an existing FS may be used to replicate a caisson. Moreover, the caissons may have configurations that are post-tensioned throughout the structure, rather than just the joints. As another example, the FS may be configured (e.g., narrow and wide) with joints running in only one dimension. In certain cases, the FS may have a deck and an elevator. Extensions of the deck relative to the elevator may facilitate co-location of the deck's center of buoyancy. Moreover, in some configurations, the deck and the elevator are interlocked to reduce relative motion and increase the stiffness and strength of the deck. In some implementations, the FS is configured to allow two or more instances of the FS to be coupled to each other, thereby defining a coupled FS system. In these implementations, the two or more instances of the FS may be moored around the perimeter of the coupled FS system to reduce the number of mooring lines. As yet another example, the FS may include a positively buoyant elevator. In some implementations, the FS may be used with a feedering barge for assembling floating wind turbine. In some implementations, two instances of the FS may be used in combination to align caissons for joining on their elevators. Such joining may include the use of post tensioning tendons or other reinforcements. In some implementations, two instances of the FS may be used in combination to raise or lower component, such as by using their elevators simultaneously.

In some implementations, the FS includes integrated concrete construction equipment with a low-cost, high-load-capacity floating dock. The FS also includes a built-in high-capacity shiplift which serves as both platform for manufacturing and an elevator for lowering structures into the water and retrieving them. This combination of features can allow the FS to operate as an FS manufacturing system. Moreover, in certain cases, the FS can be sized to lift a fully assembled offshore energy structures with assembled components, thereby allowing repairs, refurbishment, or decommissioning of the structures. The FS can also improve constructability and reduce its draft in a body of water. For example, the FS can use lightweight, low-carbon concrete and reinforcement. The FS can also use automated additive manufacturing with concrete (e.g., 3D concrete printing or spraying) to construct the concrete caissons that comprise an FS. As another example, the FS may be constructed using in-water joining of floating concrete caissons to construct its deck and elevator. The concrete caissons can, in some instances, also be arranged and designed to have post-tensioning reinforcement, such as through an entire structure defined by the concrete caissons (e.g., the deck, the elevator, etc.). Furthermore, the FS may allow for manufacturing an additional FS, such as by manufacturing caissons for the additional FS on an existing FS. This process may allow the FS to replicate itself or manufacture other FS configurations. The process may also allow for construction of caissons larger than possible on land.

In some implementations, the FS is manufactured from modular caissons made from lightweight, high-strength reinforced concrete. Advantages of concrete structures include a long service life (e.g., 50 to 80 years), low maintenance, the use of local materials and existing supply chains, a small carbon footprint, and cost-effectiveness. In some instances, the modular caissons include a floating, watertight box that is formed of cementitious material. The modular caissons can also be configured to join together, thereby creating a stable foundation for large structures (e.g., an MPH system). In some instances, the modular caissons include thin concrete walls that are supported by reinforcing stiffening walls spaced throughout their structure. The stiffening walls can also be configured to create buoyancy chambers in the caisson to facilitate ballasting using water or other ballast materials. FIG. 19 presents a schematic diagram, in bottom perspective view, of an example deck caisson for a floating shiplift. The bottom wall of the deck caisson has been omitted in FIG. 19 to show an internal cavity of the example deck caisson. The internal cavity is partitioned into a plurality of sub-cavities (e.g., square or rectangular sub-cavities) using stiffening walls that extend through the internal cavity. The sub-cavities have varying size and depth, and in certain cases, may be part of a buoyancy chamber of the deck caisson.

By leveraging the design flexibility enabled by 3DCP, the size of a concrete caisson can be adjusted to site-specific limiting conditions such as quay bearing capacity and available transport and hoisting equipment. Alternatively, an existing FS can be used to construct concrete caissons in the water to build additional/larger FSs if needed (e.g., FS-replication).

In some implementations, the FS includes caissons that are fabricated using concrete manufacturing methods such as slip forming and casting. However, the caissons may also be fabricated using advanced manufacturing methods such as additive concrete manufacturing (e.g., 3D concrete printing, 3D concrete spraying, etc.). 3DCP can be used to industrialize production and facilitate fabrication of caissons of varying size and shapes. 3DCP encompasses several technologies including binder jetting, shotcrete, and extrusion. 3DCP can often reduce construction costs and increase throughput by eliminating expensive, heavy, space-consuming formwork as well as efficiently using domestically available concrete materials in a relatively small footprint. 3DCP also allows for incorporation of stress reducing features such as curved walls and multi-dimensional stiffening ribs that are impractical to construct using other manufacturing approaches.

In some implementations, the cementitious material utilized for manufacturing caissons includes a lightweight, high-strength concrete formulated for marine durability. Steel rebar and post-tensioning tendons can also be used to reinforce the concrete materials. Other reinforcement materials include basalt and recycled fiberglass bars, meshes, and fibers. These latter materials do not corrode, can be lighter and safer to work with than steel, have excellent mechanical properties, and often have low carbon footprints.

In some implementations, the caissons are launched individually and joined in the water. This process can reduce the lift capacity required for deploying an assembled FS, especially if the FS is bulky or heavy (e.g., tens of thousands of tons). In some implementations, the two instances of the FS may be used in combination to align the caissons for joining on their elevators.

In some cases, the first and second mechanical interfaces may include respective male and female portions that are configured to mate with each other. For example, the first mechanical interface may include a protrusion, and the second mechanical interface may include a notch. The notch may be shaped to contain the protrusion but allow motion along only one direction, e.g., a perpendicular to a surface of the body of water on which the first and second caissons float. FIG. 26A presents a schematic diagram, in perspective view, of an example deck caisson 2600 having two mechanical interfaces 2602, 2604 with respective male and female portions 2606, 2608. The male portion 2606 is configured to mate with the female portion of another deck caisson. Similarly, the female portion 2608 is configured to mate with the male portion of another deck caisson. The example deck caisson 2600 may also include channels 2610 through which reinforcing materials (e.g., post-tensioning tendons) can be disposed. FIG. 26B presents a schematic diagram, in perspective view, of the example deck caisson 2600 of FIG. 26A but in which the mechanical interfaces 2602, 2604 are interlocked with the mechanical interfaces of neighboring deck caissons. The male and female portions 2606, 2608 mated to, respectively, the female and male portions of the neighboring deck caissons. FIG. 26C presents a schematic diagram, in transparent view, of the example deck caisson 2600 of FIG. 26B but showing the details of the interlocked mechanical interfaces 2602, 2604, including the channels 2610 for the reinforcement materials.

In some implementations, the caissons may be joined using a wet-mating process and corresponding joint design. The wet-mating process and joint design allow for the joining of floating concrete caissons to create a structurally monolithic, code compliant, and scalable floating platform. In the wet-mating process, reinforcement is installed in a caisson body during the manufacture of the caisson. Additional reinforcement is then installed at the joint after the caissons are joined in the water. The wet-mating process allows for normal reinforcement and tendon installation in a joint between caissons to be carried out before the joint is concreted. No underwater activity or diving is required to perform the connection between the modules. Moreover, in some cases, the interface between the caisson modules has the same properties (e.g., cross-section, materials, reinforcements) as the caissons themselves, so the reinforcement is fully continuous in the final connection.

In some implementations, the caissons can be joined using post-tensioning reinforcement that extends through the caissons, thereby extending through an entire structure defined by the caissons. For example, a structure may be defined by two caissons, and a post-tensioning tendon may extend through the two caissons and a caisson joint therebetween. In certain configurations, the post-tensioning tendon may extend between opposite ends of the structure and many also place the structure in compression. In these implementations, the caissons may be joined together using interlocking mechanical interfaces. Moreover, in further implementations, pairs of the interlocking mechanical interfaces may include respective male and female portions that are configured to mate with each other.

In some implementations, the FS includes an elevator (e.g., a shiplift elevator). In these implementations, the FS may include a hoisting system (e.g. a series of chain jacks, strand jacks, or winches) and joined modular concrete caissons. In certain cases, the elevator is configured to sink when unloaded (e.g., be negatively buoyant). In other cases, the elevator is configured to be positively buoyant, such as by incorporating buoyancy chambers.

In some implementations, the elevator includes hollow caissons that are positively buoyant in order to increase the lifting capacity of the FS. This positive buoyancy may also reduce the draft of the FS. A shallower draft may be desirable so that the FS can be operated in ports of virtually all depths, including shallow ports. In addition, a positively buoyant elevator can be structurally more efficient and use less materials, especially relative to a negatively buoyant elevator. Moreover, the positively buoyant elevator can be supported more evenly by the buoyant force of the water when compared to a non-buoyant elevator. Non-buoyant elevators are typically supported near the edges primarily by hoisting equipment on the deck of an FS. Such edge support can create large bending stresses in the elevator from gravity acting on its mass. Cargo on the elevator, if present, may further add to this stress. Furthermore, when the positively buoyant elevator is unladen (e.g., has no structure to lift), the positively buoyant elevator can be submerged by flooding the buoyancy chamber with water ballast (or by adding another type of ballast on the elevator to lower it).

In some implementations, one end of the elevator is open to the body of water to allow launching of deep draft and tall marine energy structures. For example, the deck of the FS may have a slip that provides direct access to the body of water. The elevator may occupy the slip such that one of its sides is unbounded by the deck, thereby also allowing the unbounded side direct access to the body of water. In certain cases, the structure of an MPH system, when manufactured by the FS, is positioned directly over both the center of buoyancy of the elevator and the center of buoyancy of the deck. This positioning can reduce the amount of ballast required to maintain the deck and the elevator approximately level. In some implementations, the deck is configured so that it extends past the elevator when in the slip. This configuration may align the center of buoyancy of the deck with the center of buoyancy of the elevator. For example, the deck and the elevator may have respective centers of buoyancy that are co-incident. Such alignment can reduce the amount of ballast required to level the FS when supporting a marine energy structure.

In some implementations, the FS is configured to support several types of automated concrete manufacturing directly on the elevator. This configuration may eliminate hoisting and skidding operations that are otherwise required for structures manufactured on shore-based wharves. A variety of concrete construction methods can be performed on the elevator. For example, 3DCP can be performed using flying gantry printers with tracks, as shown in FIG. 17A or standard gantry printers, as shown in FIGS. 13A-13B. The systems for 3DCP can be deployed in a “field environment”, such as the FS, and include motion compensation systems for 3D printers allow their use on floating platforms. As another example, slip forming and casting can also be performed on the FS. FIG. 20 presents a schematic diagram, in perspective view, of an example floating shiplift 2000 that includes a slip-forming frame 2008 on a deck 2010 of the example FS 2000. The example floating shiplift 2000 is being used to slipform an marine energy structure with five cylindrical elements. Slip forming can be used to construct large concrete renewable energy and marine infrastructure components both onshore and on floating platforms. Moreover, slip forming and 3DCP often require little or no formwork to fabricate monolithic foundations in a small footprint.

In some implementations, the FS is configured to join precast concrete or pre-manufactured steel foundations. For example, the FS may be outfitted with a gantry crane or have access to a nearby wharf crane or barge crane.

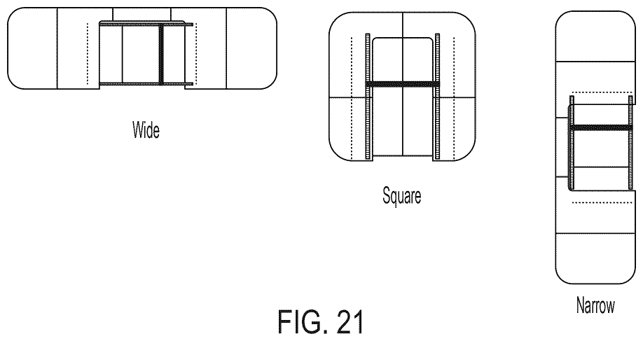

In many implementations, the FS can be scaled to virtually any size and capacity to support a variety of offshore structures and sizes. For example, the number, aspect ratio, and types of FS stations-including the type of manufacturing and assembly equipment placed on each FS station-can be tailored to meet site-specific needs. These features depend on site-specific needs for different ports and regions as well as the requirements of the offshore energy structure to be fabricated. FIG. 21 presents a schematic diagram, in top view, of example aspect ratios for a floating shiplift. The leftmost portion of FIG. 21 shows an example of a wide aspect ratio for the FS, and the rightmost portion of FIG. 21 shows an example of a narrow aspect ratio for the FS. The latter ratio can allow the FS can be positioned alongside a pier, or perpendicular to a pier, depending on the space available at the pier. The wide and narrow aspect ratios in FIG. 21 are depicted with a flying gantry-style printer over the elevator. This location can reduce a width of the gantry-style printer and may include caissons with joints in only one direction. Such alignment can simplify joining operations during construction of the FS. A square aspect ratio, shown in the center portion of FIG. 21, has better seakeeping ability due to its symmetry. However, the square aspect ratio includes both vertical and horizontal joints in the FS, which make manufacturing and joining the FS more complicated.

As noted above, the wide and narrow configurations allow the FS to be positioned alongside a pier, or perpendicular to a pier, depending on the space available at the pier. However, like with the square configuration, they can allow the FS to be moored independently, or alternatively, allow multiple FS stations to be coupled together, such as for mooring in a sheltered water location (e.g., the middle of a harbor). In addition, the wide and narrow configurations can simplify construction by using one-dimensional joints between the caissons. These linear joints can run parallel to each other, which can reduce the complexity of the post-tensioning operations used for joining the caissons. In contrast, the square configuration may, in certain cases, require manufacturing of the caissons with joints in two dimensions in order to keep the caisson size small enough to manufacture.

Manufacturing equipment can be placed on the elevator of the FS, the deck of the FS, or both. Hower, in some configurations, the manufacturing equipment is placed on the elevator, which may avoid relative motion between the elevator and the manufacturing equipment located on the deck. The wide and narrow aspect ratios illustrated in FIG. 21 for the FS show example configurations where the manufacturing equipment is located on the elevator. In contrast, the square aspect ratio in FIG. 21 shows an example configuration where the manufacturing equipment is located on the deck. Placing the manufacturing equipment on the elevator can, in certain cases, reduce the span of the equipment needed to manufacture on the deck. For example, a 3D printer mounted on the deck of a wide FS may need a span of 80-m or more. However, a flying gantry 3D printer located on the deck in the transverse direction of the elevator may require a span of only 50-m or less.

However, in some cases, placing the equipment on the deck can help protect it from direct exposure to water that might otherwise cause corrosion of the manufacturing equipment. In these cases, the FS can be designed to have the elevator physically engage the deck when the elevator reaches its highest position. Friction forces or interlocking design between the deck and elevator will reduce the relative motion between the two components. FIG. 22A presents a schematic diagram, in exploded perspective view, of an example floating shiplift having its deck and elevator disengaged. The elevator is lowered relative to the deck. FIG. 22B presents a schematic diagram, in perspective view, of the example floating shiplift of FIG. 22A but in which the deck and elevator are engaged. This engagement may lock the elevator in place relative to the deck, such as by friction. However, in certain cases, a locking mechanism may be used. An added benefit of having the elevator engage the deck is that, in many situations, the combined structure (e.g., the elevator and the deck), can stiffen and strengthen the deck to help the FS resist forces on the deck from wind and waves better. In some implementations, a roof structure and wall structures are built above the FS on the deck or elevator. These structures may shield the manufacturing operation from the elements (e.g., sun, wind, rain, etc.).

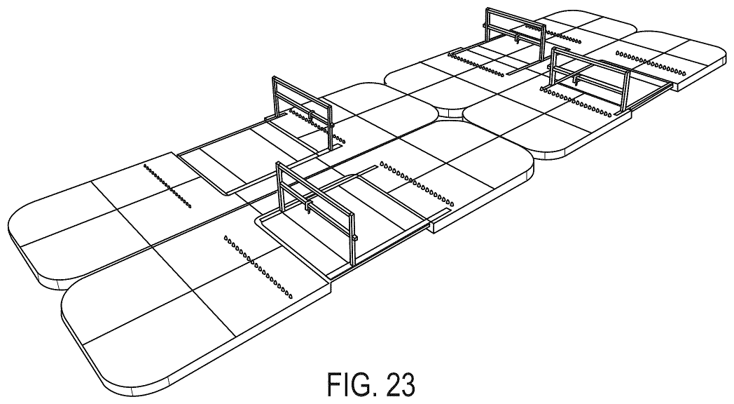

In some implementations, the FS has a relatively small footprint in the body of water. The relatively small footprint can allow the use of multiple FS manufacturing stations, such as for the serialized production of foundations. For example, four FS stations—each with 3D printing and/or slip forming capability—may be used to achieve a combined manufacturing throughput of one large structure per week. The FS stations can be relocated to different locations within ports or to nearby ports to accommodate space constraints. The FS stations can also be relocated to support planned shore-based operations. In certain cases, one or more FS stations can be joined to each other to form an “FS island”. FIG. 23 presents a schematic diagram, in perspective view, an example FS island that includes four FS stations. Mooring lines (not shown) can be installed around the perimeter of the example FS island to secure the island in place. The FS island can centralize operations to provide manufacturing efficiencies. Moreover, the FS-island can be temporarily coupled together and mooring lines places around its periphery. This configuration (e.g., as opposed to mooring each individual FS station) can reduce the total number of mooring lines and anchors needed to restrain the FS island in the body of water.

In some implementations, the FS is configured for a 15,000-ton lift capacity. The mass of the FS may be about 48,000 tons. This configuration may allow the manufacture of floating wind turbine foundations with a turbine tower, rotor, and nacelle installed. However, larger lift capacities are possible. For example, the FS may be configured with a 30,000-ton FS capacity that is sufficient capacity to lift foundations for a 25-MW wind turbine with the turbine installed. The mass of the FS in this configuration may be about 101,000 tons. Both configurations of the FS can launch and retrieve assembled turbines in ports of 12-m draft without moving the FS to a deeper location, such as by using tugboats. However, if required for deeper draft foundations or in shallow ports, the FS can be towed with the foundation and turbine on-board like a semi-submersible barge to facilitate assembly, launching, or retrieval in deeper water.

In some implementations, the FS is configured for foundation (e.g., wind turbine foundation) launching and retrieving. After an marine energy structure (e.g., a foundation) has been manufactured onboard an FS, the FS can launch the marine energy structure by lowering the elevator into the water. The foundation can then be wet-towed to either an assembly station, or if necessary, to a wet-storage site. For retrieval, the elevator is lowered into the water before the structure is floated over it and lifted either with or without the full turbine assembled. In contrast, conventional modular dock structures require the entire deck to be submerged, reducing hydrostatic stability of the dock and flooding everything onboard, making it unsuitable for retaining personnel or manufacturing equipment on the deck, or for use in marginal wind and wave conditions. These modular dock structures also cannot achieve the deck stiffness and bearing capacities needed for the manufacturing and hoisting of concrete foundations. Moreover, they are made from expensive steel components susceptible to corrosion and biofouling.

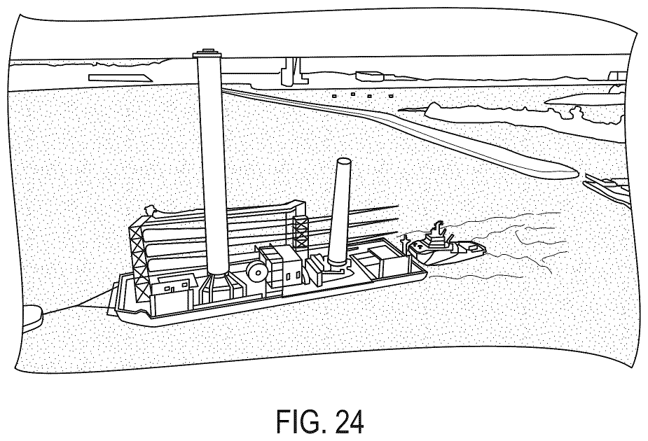

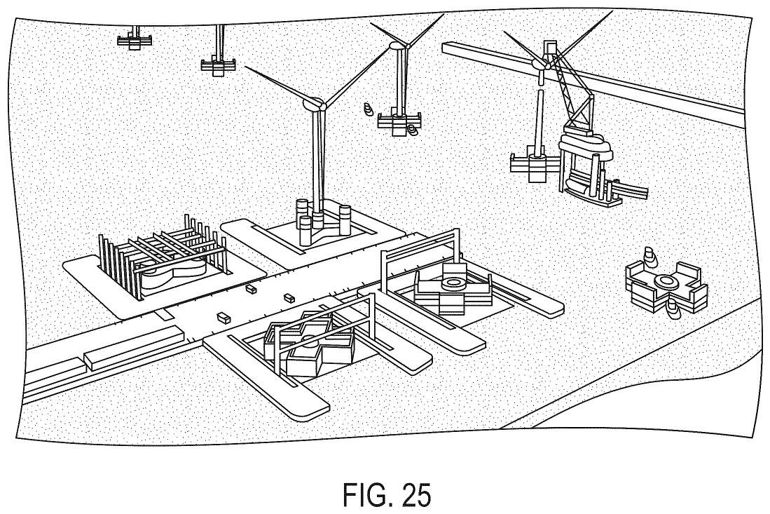

In some implementations, the FS is operated as part of a turbine marshalling and assembly strategy. This strategy may be used with floating offshore wind (FOW) turbines. In these implementations, the FS can be used with a feedering component supply strategy to begin assembling and deploying complex marine energy systems such as offshore wind turbines. This assembly and deployment is much sooner than is otherwise possible with conventional assembly and marshalling facilities. Feedering is a component supply strategy that can be adapted for assembling FOW turbines in a sheltered harbor using smaller, more readily available vessels. FIG. 24 presents a schematic diagram of an example “feedering” process in which components of a FOW turbine are transported out to a wind turbine installation vessel (WTIV). In this process, feeder barges bring turbine components from ships or nearby ports directly to an assembly site, increasing assembly efficiency by reducing installation vessel down-time. FIG. 25 presents a schematic diagram showing an example “feedering” process that uses four FS stations. The four FS stations are paired with a feedering component supply strategy to being the assembly and deployment of turbine foundations. The turbine foundations may be for respective FOW turbines are manufactured on an FS station using one or both of 3DCP and slip forming.

In some aspects of what is described, a system for storing energy underwater may be described by the following examples:
Example 1. A system for storing energy underwater, comprising:
   a base having a bottom side resting on an underwater floor and a top side comprising a plurality of recessed surfaces;
   a plurality of domed walls extending from the top side of the base to form respective fluid chambers, each of the fluid chambers comprising an interior volume that is at least partially defined by one of the recessed surfaces and an interior surface of one of the domed walls;
   a pump configured to pump water (e.g., along a first flow path) from the fluid chambers toward an exterior environment of the system; and
   a generator configured to generate electrical energy in response to water flowing (e.g., along a second flow path) from the exterior environment toward the fluid chambers.
Example 2. The system of example 1, wherein the base comprises a conduit system that provides fluid communication between the fluid chambers.
Example 3. The system of example 2, wherein the base comprises interior surfaces that define the conduit system.
Example 4. The system of example 2 or example 3, wherein the conduit system provides fluid communication between the pump and the fluid chambers and defines at least part of a flow path (e.g., the first flow path) extending between the fluid chambers and the exterior environment of the system.
Example 5. The system of example 2 or any one of examples 3-4, wherein the conduit system provides fluid communication between the generator and the fluid chambers and defines at least part of a flow path (e.g., the second flow path) extending between the fluid chambers and the exterior environment of the system.
Example 6. The system of example 2 or any one of examples 3-5, wherein the recessed surfaces of the base define respective conduit ports to the conduit system.
Example 7. The system of example 1 or any one of examples 2-6, wherein the base and the plurality of domed walls are an integral body.
Example 8. The system of example 1 or any one of examples 2-6, wherein the base and the plurality of domed walls are separate bodies, and each of the domed walls comprises a perimeter edge encircling an opening of the domed wall, and the perimeter edge is sealed to the top side of the base.
Example 9. The system of example 1 or any one of examples 2-8, comprising:
   a pump housing containing the pump and coupled to the base, the pump housing comprising first and second pump housing ports; and
   a generator housing containing the generator and coupled to the base, the generator housing comprising first and second generator housing ports.
Example 10. The system of example 9,
   wherein a first flow path extends between the fluid chambers and the exterior environment of the system and comprises at least a portion extending through the pump housing between the first and second pump housing ports;
   wherein the pump is configured to pump water along the first flow path from the fluid chambers toward the exterior environment;
   wherein a second flow path extends between the fluid chambers and the exterior environment of the system and comprises at least a portion extending through the generator housing between the first and second generator housing ports, the second flow path distinct from the first flow path; and
   wherein the generator is configured to generate electrical energy in response to water flowing along the second flow path from the exterior environment toward the fluid chambers.
Example 11. The system of example 1 or any one of examples 2-8, comprising:
   a housing containing a combined pump/generator assembly that comprises the pump and the generator, the housing coupled to the base and comprising first and second housing ports.
Example 12. The system of example 11,
   wherein a third flow path extends between the fluid chambers and the exterior environment of the system and comprises at least a portion extending through the housing between the first and second housing ports;
   wherein the pump is configured to pump water along the third flow path from the fluid chambers toward the exterior environment;
   wherein the generator is configured to generate electrical energy in response to water flowing along the third flow path from the exterior environment into the fluid chambers.
Example 13. The system of example 1 or any one of examples 2-12, comprising an anchor coupling the base to the underwater floor.
Example 14. The system of example 13, wherein the anchor is a suction pile.
Example 15. The system of example 1 or any one of examples 2-14, wherein the base comprises a buoyancy chamber.
Example 16. The system of example 1 or any one of examples 2-15, wherein the base comprises a pocket configured to hold ballast material, the pocket having an opening accessible from an exterior of the base.
Example 17. The system of example 1 or any one of examples 2-16, comprising an electrical cable that communicates electrical power between an onshore electrical system and one or both of the pump and the generator.
Example 18. The system of example 1 or any one of examples 2-17, comprising an electrical cable that communicates electrical power between an offshore platform and one or both of the pump and the generator.
Example 19. The system of example 1 or any one of examples 2-18, comprising an electrical cable that communicates electrical power between a transformer and one or both of the pump and the generator.
Example 20. The system of example 19, wherein the transformer is electrically coupled to a wind turbine.
Example 21. The system of example 19 or example 20, wherein the transformer is electrically coupled to a solar panel.
Example 22. The system of example 1 or any one of examples 2-21, wherein one or more of the plurality of domed walls are formed at least in part of hardened layers of cementitious material deposited successively on top of each other.
Example 23. The system of example 1 or any one of examples 2-22, wherein the base is formed at least in part of hardened layers of cementitious material deposited successively on top of each other.

In some aspects of what is described, a method for storing energy underwater may be described by the following examples:
Example 24. A method for storing energy underwater comprising:
   pumping water (e.g., along a first flow path) from fluid chambers of an underwater energy storage system to an exterior environment of the underwater energy storage system, the underwater energy storage system comprising:
      a base having a bottom side resting on an underwater floor and a top side comprising a plurality of recessed surfaces;
      a plurality of domed walls extending from the top side of the base to form the respective fluid chambers, each of the fluid chambers comprising an interior volume that is at least partially defined by one of the recessed surfaces and an interior surface of one of the domed walls;
   generating electrical energy in response to water flowing (e.g., along a second flow path) from the exterior environment into the fluid chambers.
Example 25. The method of example 24,
   wherein the exterior environment comprises water having a hydrostatic pressure; and
   wherein pumping water comprises transporting the water into the exterior environment against the hydrostatic pressure to store energy.
Example 26. The method of example 24 or example 25,
   wherein the exterior environment comprises water having a hydrostatic pressure; and
   wherein generating electrical energy comprises driving water into the fluid chambers by action of the hydrostatic pressure.
Example 27. The method of example 24 or any one of examples 25-26,
   wherein the base comprises a conduit system providing fluid communication between the fluid chambers; and
   wherein the conduit system defines at least part of the first and second flow paths.
Example 28. The method of example 27,
   wherein pumping water comprises transporting water through the conduit system from the fluid chambers towards the exterior environment; and
   wherein generating electrical energy comprises transporting water through the conduit system from the exterior environment towards the fluid chambers.
Example 29. The method of example 24 or any one of examples 25-28,
   wherein pumping water comprises transporting water along a first flow path from the fluid chambers toward the exterior environment;
   wherein the electrical energy is generated in response to water flowing along a second flow path from the exterior environment toward the fluid chambers; and
   wherein the first and second flow paths are distinct from each other.
Example 30. The method of example 24 or any one of examples 25-28,
   wherein pumping water comprises transporting water along a first flow path from the fluid chambers toward the exterior environment;
   wherein the electrical energy is generated in response to water flowing along a second flow path from the exterior environment toward the fluid chambers; and
   wherein the first and second flow paths are the same flow path.
Example 31. The method of example 24 or any one of examples 25-30, comprising: supplying electrical energy to a pump;
   wherein the pump uses the supplied electrical energy to pump water into the exterior environment.
Example 32. The method of example 31, wherein supplying the electrical energy comprises:
   receiving, at a transformer, electrical energy from a source of electrical energy; and
   transforming, by operation of the transformer, the received electrical energy to produce the supplied electrical energy (e.g., transforming voltage, a current, or a phase of the electrical energy).
Example 33. The method of example 31 or example 32, comprising:
   converting, by operation of a solar panel, solar energy into a solar-derived electrical energy; and
   wherein supplying the electrical energy comprises transferring the solar-derived electrical energy to the pump.
Example 34. The method of example 31 or any one of examples 32-33, comprising:
   converting, by operation of a wind turbine, wind energy into a wind-derived electrical energy; and
   wherein supplying the electrical energy comprises transferring the wind-derived electrical energy to the pump.
Example 35. The method of example 24 or any one of examples 25-34, comprising:
   providing, through an electrical cable, the generated electrical energy to an electrical system.
Example 36. The method of example 35, wherein providing the generated electrical energy comprises:
   receiving, at a transformer, the generated electrical energy; and
   transforming, by operation of the transformer, the generated electrical energy.
Example 37. The method of example 35 or example 36,
   wherein the electrical system is disposed at an onshore location; and
   wherein providing the generated electrical energy comprises transferring the generated electrical energy to the onshore location.
Example 38. The method of example 35 or example 36,
   wherein the electrical system is disposed on an offshore platform; and
   wherein providing the generated electrical energy comprises transferring the generated electrical energy to the offshore platform.
Example 39. The method of example 24 or any one of examples 25-38, comprising:
   submerging the underwater energy storage system in a body of water; and
   coupling the base of the underwater energy storage system to the underwater floor, thereby allowing the bottom side of the base to rest on the underwater floor.
Example 40. The method of example 39, wherein submerging the underwater energy storage system comprises receiving water into a buoyancy chamber of the base.
Example 41. The method of example 39 or example 40, comprising receiving ballast material into a pocket of the base, the pocket configured to hold ballast material and having an opening accessible from an exterior of the base.
Example 42. The method of example 39 or any one of examples 40-41, comprising:
   decoupling the base of the underwater energy storage system from the underwater floor, thereby allowing the bottom side of the base to separate from the underwater floor; and
   raising the underwater energy storage system out of the body of water.
Example 43. The method of example 42, wherein raising the underwater energy storage system comprises discharging water from a buoyancy chamber of the base.
Example 44. The method of example 42 or example 43, comprising removing ballast material from a pocket of the base, the pocket configured to hold ballast material and having an opening accessible from an exterior of the base.

In some aspects of what is described, a submersible barge may be described by the following examples. The submersible barge may include an additive manufacturing system and a buoyancy system.
Example 45. A submersible barge comprising:
   a deck having a support surface;
   an additive manufacturing system configured to fabricate a cementitious body on the support surface by successively depositing layers of flowable cementitious material on top of each other; and
   a buoyancy system configured to lower the cementitious body into a body of water by altering a draft of the submersible barge between a first draft, where the support surface resides above a surface of a body of water, and a second draft, where the support surface resides below the surface of the body of water.
Example 46. The submersible barge of example 45, wherein the additive manufacturing system comprises a mixer that mixes fibrous reinforcement materials into the flowable cementitious material.
Example 47. The submersible barge of example 45 or example 46, wherein the additive manufacturing system comprises an assembly system that assembles mesh or cable reinforcement into a support structure that receives the successively deposited layers of flowable cementitious material.
Example 48. The submersible barge of example 45 or any one of examples 46-47, wherein the additive manufacturing system comprises a 3D printer that successively prints layers of flowable cementitious material on top of each other.
Example 49. The submersible barge of example 45 or any one of examples 46-48, wherein the additive manufacturing system comprises a spraying system that successively sprays layers of flowable cementitious material on top of each other.
Example 50. The submersible barge of example 45 or any one of examples 46-49, comprising a hoisting system adjacent to the deck and configured to lift the cementitious body, when fabricated, from the support surface.
Example 51. The submersible barge of example 45 or any one of examples 46-50,
   wherein the cementitious body defines a base for a plurality of domed walls;
   wherein the base comprises bottom and top sides, the bottom side configured to rest on a floor of the body of water, the top side having a plurality of recessed surfaces; and
   wherein the plurality of domed walls extend from the top side of the base to form respective fluid chambers, each of the fluid chambers comprising an interior volume that is at least partially defined by one of the recessed surfaces and an interior surface of one of the domed walls.

In some aspects of what is described, a method may be described by the following examples. In some cases, the method corresponds to a method of operating a submersible barge, such as one that includes an additive manufacturing system and a buoyancy system.
Example 52. A method comprising:
   by operation of an additive manufacturing system that is supported by a submersible barge in a body of water, depositing successive layers of flowable cementitious material on top of each other to form a cementitious body on a support surface of the submersible barge, wherein the flowable cementitious material hardens into a solidified cementitious material;
   by operation of a buoyancy system of the submersible barge, altering a draft of the submersible barge from a first draft, where the support surface resides above a surface of the body of water, to a second draft, where the support surface resides below the surface of the body of water, thereby lowering the cementitious body into the body of water.

Example 53. The method of example 52,
wherein the additive manufacturing system comprises a mixer; and
wherein the method comprises mixing fibrous reinforcement materials into the flowable cementitious material by operation of the mixer.

Example 54. The method of example 52 or example 53,
wherein the additive manufacturing system comprises an assembly system; and
wherein the method comprises assembling, by operation of the assembly system, mesh or cable reinforcement into a support structure that receives the successively deposited layers of flowable cementitious material.

Example 55. The method of example 52 or any one of examples 53-54,
wherein the additive manufacturing system comprises a 3D printer; and
wherein successively depositing layers comprises successively printing layers of flowable cementitious material on top of each other by operation of the 3D printer.

Example 56. The method of example 52 or any one of examples 53-55,
wherein the additive manufacturing system comprises a spraying system; and
wherein successively depositing layers comprises successively spraying layers of flowable cementitious material on top of each other by operation of the spraying system.

Example 57. The method of example 52 or any one of examples 53-56,
wherein the submersible barge comprises a hoisting system; and
wherein the method comprises loading, by operation of the hoisting system, precursor materials onto the deck for forming the flowable cementitious material.

Example 58. The method of example 52 or any one of examples 53-57, comprising:
transporting, by operation of the submersible barge, the cementitious body to a target location on the body of water; and
altering, by operation of the buoyancy system, the draft of the submersible barge from the first draft to the second draft, thereby lowering the cementitious body into the body of water.

Example 59. The method of example 52 or any one of examples 53-58,
wherein the cementitious body defines a base for a plurality of domed walls;
wherein the base comprises bottom and top sides, the bottom side configured to rest on a floor of the body of water, the top side having a plurality of recessed surfaces; and
wherein the plurality of domed walls extend from the top side of the base to form respective fluid chambers, each of the fluid chambers comprising an interior volume that is at least partially defined by one of the recessed surfaces and an interior surface of one of the domed walls.

In some aspects of what is described, a floating shiplift may be described by the following examples. The floating shiplift may include an additive manufacturing system.
Example 60. A floating shiplift, comprising:
   a deck comprising deck caissons that are coupled to each other and float on a body of water, the deck caissons arranged to define a slip of the deck;
   an elevator residing in the slip and comprising elevator caissons that are coupled to each other;
   a hoisting system coupling the elevator to the deck and configured to selectively raise and lower and the elevator relative to the deck; and
   an additive manufacturing system configured to fabricate a cementitious body on the elevator by performing operations that comprise successively depositing layers of flowable cementitious material on top of each other.
Example 61. The floating shiplift of example 60, wherein the deck and elevator caissons are configured such that the deck and the elevator have respective centers of buoyancy that are aligned with each other.
Example 62. The floating shiplift of example 60 or example 61,
   wherein the deck caissons or the elevator caissons comprise first and second caissons that are coupled to each other at a caisson joint; and
   wherein a post-tensioning tendon extends through the first caisson, the caisson joint, and the second caisson.
Example 63. The floating shiplift of example 60 or any one of examples 61-62, wherein the deck caissons or the elevator caissons comprise pairs of caissons that are coupled to each other at respective linear caisson joints, the respective linear caisson joints aligned parallel to each other.
Example 64. The floating shiplift of example 60 or any one of examples 61-63, wherein one or both of the deck caissons and the elevator caissons are each formed of cementitious material and comprise:
   top and bottom walls separated by an internal cavity of the caisson, the bottom wall oriented towards the body of water;
   a perimeter wall that extends between the top and bottom walls and surrounds the internal cavity, the perimeter wall defining a perimeter of the caisson; and
   one or more stiffening walls in the internal cavity that extend between the top and bottom walls and partition the internal cavity into a plurality of sub-cavities.
Example 65. The floating shiplift of example 64,
   wherein at least one elevator caisson has a buoyancy chamber that comprises one or more sub-cavities of the at least one elevator caisson, the one or more sub-cavities in fluid communication with each other; and
   wherein the buoyancy chamber comprises a port that is configured to receive water into, or discharge water from, the one or more sub-cavities.
Example 66. The floating shiplift of example 64 or example 65,
   wherein the deck caissons or the elevator caissons comprise:
      a first caisson having a first mechanical interface on the perimeter wall of the first caisson,
      a second caisson having a second mechanical interface on the perimeter wall of the second caisson, and
   wherein the first and second mechanical interfaces interlock with each other to couple the first caisson to the second caisson.
Example 67. The floating shiplift of example 64 or any one of examples 65-66,
   wherein the top walls of the deck caissons comprise respective top surfaces that are co-planar with each other and define a planar deck surface of the deck; and
   wherein the top walls of the elevator caissons comprise respective top surfaces that are co-planar with each other and define a planar elevator surface of the elevator.
Example 68. The floating shiplift of example 68, wherein the hoisting system is configured to selectively raise and lower and the elevator between an upper position, where the planar elevator surface is level with the planar deck surface, and a lower position, where the planar elevator surface resides below a surface of the body of water.
   Example 69. The floating shiplift of example 64 or any one of examples 65-68, wherein the top wall of at least one elevator caisson comprises a step that transitions between a lower surface and an upper surface of the top wall; and
   wherein the at least one elevator caisson is positioned relative to the deck such that the lower surface of the top wall resides below the bottom walls of one or more deck caissons.
Example 70. The floating shiplift of example 60 or any one of examples 61-69, wherein the additive manufacturing system is disposed on the elevator and coupled thereto.
Example 71. The floating shiplift of example 60 or any one of examples 61-70, wherein the additive manufacturing system comprises a 3D printer that successively prints layers of flowable cementitious material on top of each other.
Example 72. The floating shiplift of example 60 or any one of examples 61-71, wherein the additive manufacturing system comprises a spraying system that successively sprays layers of flowable cementitious material on top of each other.
Example 73. The floating shiplift of example 60 or any one of examples 61-72, wherein the additive manufacturing system comprises a slip-forming system that successively slip-forms layers of flowable cementitious material on top of each other, the slip-formed layers defining respective sections of the cementitious body.
Example 74. The floating shiplift of example 60 or any one of examples 61-73, wherein the additive manufacturing system comprises a mixer that mixes fibrous reinforcement materials into the flowable cementitious material.
Example 75. The floating shiplift of example 60 or any one of examples 61-74, wherein the additive manufacturing system comprises an assembly system that assembles mesh or cable reinforcement into a support structure that receives the successively deposited layers of flowable cementitious material.

In some aspects of what is described, a method may be described by the following examples. In some cases, the method corresponds to a method of operating a floating shiplift, such as one that includes an additive manufacturing system (e.g., a 3D printing system, a spray system, etc.).
Example 76. A method, comprising:
   by operation of an additive manufacturing system of a floating shiplift, depositing successive layers of flowable cementitious material on top of each other to fabricate a cementitious body on an elevator of the floating shiplift, the floating shiplift comprising:
      a deck comprising deck caissons that are coupled to each other and floating on a body of water, the deck caissons arranged to define a slip of the deck, the elevator residing in the slip and comprising elevator caissons that are coupled to each other, and
      a hoisting system coupling the elevator to the deck and configured to selectively raise and lower and the elevator relative to the deck; and
   hardening the flowable cementitious material into a solidified cementitious material, thereby fabricating the cementitious body.
Example 77. The method of example 76, comprising:
   lowering, by operation of the hoisting system, the elevator to a lower position where the elevator resides below a surface of the body of water; and
   moving the cementitious body off the elevator into the body of water.
Example 78. The method of example 77,
   wherein each elevator caisson comprises:
      top and bottom walls separated by an internal cavity of the caisson, the bottom wall oriented towards the body of water, and
      one or more stiffening walls in the internal cavity that extend between the top and bottom walls and partition the internal cavity into a plurality of sub-cavities;
   wherein at least one elevator caisson has a buoyancy chamber that comprises one or more sub-cavities of the at least one elevator caisson, the one or more sub-cavities in fluid communication with each other; and
   wherein lowering the elevator comprises filling, by operation of a pump of the hoisting system, the buoyancy chamber of at least one elevator caisson with water.
Example 79. The method of example 78, comprising:
   wherein the buoyancy chamber comprises a port that is configured to receive water into, or discharge water from, the one or more sub-cavities; and
   wherein filling the buoyancy chamber of the at least one elevator caisson comprises displacing, by operation of the pump, water through the port of the buoyancy chamber.
Example 80. The method of example 76 or any one of examples 77-79, wherein one or both of the deck caissons and the elevator caissons are each formed of cementitious material and comprise:
   top and bottom walls separated by an internal cavity of the caisson, the bottom wall oriented towards the body of water;
   a perimeter wall that extends between the top and bottom walls and surrounds the internal cavity, the perimeter wall defining a perimeter of the caisson; and
   one or more stiffening walls in the internal cavity that extend between the top and bottom walls and partition the internal cavity into a plurality of sub-cavities.
Example 81. The method of example 80,
   wherein the top walls of the deck caissons have respective top surfaces that are co-planar with each other and define a planar deck surface of the deck; and
   wherein the top walls of the elevator caissons define respective top surfaces that are co-planar with each other and define a planar elevator surface of the elevator.
Example 82. The method of example 81, comprising:
   raising, by operation of the hoisting system, the elevator to an upper position where the planar elevator surface is level with the planar deck surface.
Example 83. The method of example 76 or any one of examples 77-82,
   wherein the additive manufacturing system comprises a 3D printer; and
   wherein successively depositing layers comprises successively printing layers of flowable cementitious material on top of each other by operation of the 3D printer.
Example 84. The method of example 76 or any one of examples 77-83,
   wherein the additive manufacturing system comprises a spraying system; and
   wherein successively depositing layers comprises successively spraying layers of flowable cementitious material on top of each other by operation of the spraying system.
Example 85. The method of example 76 or any one of examples 77-84,
   wherein the additive manufacturing system comprises a slip-forming system; and
   wherein successively depositing layers successively slip-forming layers of flowable cementitious material on top of each other by operation of the slip-forming system, the slip-formed layers defining respective sections of the cementitious body.
Example 86. The method of example 76 or any one of examples 77-85,
   wherein the additive manufacturing system comprises a mixer; and
   wherein the method comprises mixing fibrous reinforcement materials into the flowable cementitious material by operation of the mixer.
Example 87. The method of example 76 or any one of examples 77-86,
   wherein the additive manufacturing system comprises an assembly system; and
   wherein the method comprises assembling, by operation of the assembly system, mesh or cable reinforcement into a support structure that receives the successively deposited layers of flowable cementitious material.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

What is claimed is:

1. A submersible barge comprising:
a deck having a support surface;
an additive manufacturing system configured to fabricate a cementitious body on the support surface by performing operations that comprise successively depositing layers of flowable cementitious material on top of each other; and
a buoyancy system configured to lower the cementitious body into the body of water by altering a draft of the submersible barge between a first draft, where the support surface resides above a surface of a body of water, and a second draft, where the support surface resides below the surface of the body of water.

2. The submersible barge of claim 1, wherein the additive manufacturing system comprises a mixer that mixes fibrous reinforcement materials into the flowable cementitious material.

3. The submersible barge of claim 1, wherein the additive manufacturing system comprises an assembly system that assembles mesh or cable reinforcement into a support structure that receives the successively deposited layers of flowable cementitious material.

4. The submersible barge of claim 1, wherein the additive manufacturing system comprises a 3D printer that successively prints layers of flowable cementitious material on top of each other.

5. The submersible barge of claim 1, wherein the additive manufacturing system comprises a spraying system that successively sprays layers of flowable cementitious material on top of each other.

6. The submersible barge of claim 1, comprising a hoisting system adjacent to the deck and configured to lift the cementitious body, when fabricated, from the support surface.

7. The submersible barge of claim 1,
wherein the cementitious body defines a base for a plurality of domed walls;
wherein the base comprises bottom and top sides, the bottom side configured to rest on a floor of the body of water, the top side having a plurality of recessed surfaces; and
wherein the plurality of domed walls extend from the top side of the base to form respective fluid chambers, each of the fluid chambers comprising an interior volume that is at least partially defined by one of the recessed surfaces and an interior surface of one of the domed walls.

8. A method comprising:
by operation of an additive manufacturing system that is supported by a submersible barge in a body of water, depositing successive layers of flowable cementitious material on top of each other to form a cementitious body on a support surface of the submersible barge, wherein the flowable cementitious material hardens into a solidified cementitious material;
by operation of a buoyancy system of the submersible barge, altering a draft of the submersible barge from a first draft, where the support surface resides above a surface of the body of water, to a second draft, where the support surface resides below the surface of the body of water, thereby lowering the cementitious body into the body of water.

9. The method of claim 8,
wherein the additive manufacturing system comprises a mixer; and
wherein the method comprises mixing fibrous reinforcement materials into the flowable cementitious material by operation of the mixer.

10. The method of claim 8,
wherein the additive manufacturing system comprises an assembly system; and
wherein the method comprises assembling, by operation of the assembly system, mesh or cable reinforcement into a support structure that receives the successively deposited layers of flowable cementitious material.

11. The method of claim 8,
wherein the additive manufacturing system comprises a 3D printer; and
wherein successively depositing layers comprises successively printing layers of flowable cementitious material on top of each other by operation of the 3D printer.

12. The method of claim 8,
wherein the additive manufacturing system comprises a spraying system; and
wherein successively depositing layers comprises successively spraying layers of flowable cementitious material on top of each other by operation of the spraying system.

13. The method of claim 8,
wherein the submersible barge comprises a hoisting system; and
wherein the method comprises loading, by operation of the hoisting system, precursor materials onto the deck for forming the flowable cementitious material.

14. The method of claim 8, comprising:
transporting, by operation of the submersible barge, the cementitious body to a target location on the body of water; and
altering, by operation of the buoyancy system, the draft of the submersible barge from the first draft to the second draft, thereby lowering the cementitious body into the body of water.

15. The method of claim 8,
wherein the cementitious body defines a base for a plurality of domed walls;
wherein the base comprises bottom and top sides, the bottom side configured to rest on a floor of the body of water, the top side having a plurality of recessed surfaces; and
wherein the plurality of domed walls extend from the top side of the base to form respective fluid chambers, each of the fluid chambers comprising an interior volume that is at least partially defined by one of the recessed surfaces and an interior surface of one of the domed walls.

16. A floating shiplift, comprising:
a deck comprising deck caissons that are coupled to each other and float on a body of water, the deck caissons arranged to define a slip of the deck;
an elevator residing in the slip and comprising elevator caissons that are coupled to each other;
a hoisting system coupling the elevator to the deck and configured to selectively raise and lower and the elevator relative to the deck; and
an additive manufacturing system configured to fabricate a cementitious body on the elevator by performing operations that comprise successively depositing layers of flowable cementitious material on top of each other.

17. The floating shiplift of claim 16, wherein the deck and elevator caissons are configured such that the deck and the elevator have respective centers of buoyancy that are aligned with each other.

18. The floating shiplift of claim 16,
wherein the deck caissons or the elevator caissons comprise first and second caissons that are coupled to each other at a caisson joint; and
wherein a post-tensioning tendon extends through the first caisson, the caisson joint, and the second caisson.

19. The floating shiplift of claim 16, wherein the deck caissons or the elevator caissons comprise pairs of caissons that are coupled to each other at respective linear caisson joints, the respective linear caisson joints aligned parallel to each other.

20. The floating shiplift of claim 16, wherein one or both of the deck caissons and the elevator caissons are each formed of cementitious material and comprise:
top and bottom walls separated by an internal cavity of the caisson, the bottom wall oriented towards the body of water;
a perimeter wall that extends between the top and bottom walls and surrounds the internal cavity, the perimeter wall defining a perimeter of the caisson; and
one or more stiffening walls in the internal cavity that extend between the top and bottom walls and partition the internal cavity into a plurality of sub-cavities.

21. The floating shiplift of claim 20,
wherein at least one elevator caisson has a buoyancy chamber that comprises one or more sub-cavities of the at least one elevator caisson, the one or more sub-cavities in fluid communication with each other; and
wherein the buoyancy chamber comprises a port that is configured to receive water into, or discharge water from, the one or more sub-cavities.

22. The floating shiplift of claim 20,
wherein the deck caissons or the elevator caissons comprise:
a first caisson having a first mechanical interface on the perimeter wall of the first caisson,
a second caisson having a second mechanical interface on the perimeter wall of the second caisson, and
wherein the first and second mechanical interfaces interlock with each other to couple the first caisson to the second caisson.

23. The floating shiplift of claim 20,
wherein the top walls of the deck caissons comprise respective top surfaces that are co-planar with each other and define a planar deck surface of the deck; and
wherein the top walls of the elevator caissons comprise respective top surfaces that are co-planar with each other and define a planar elevator surface of the elevator.

24. The floating shiplift of claim 23, wherein the hoisting system is configured to selectively raise and lower and the elevator between an upper position, where the planar elevator surface is level with the planar deck surface, and a lower position, where the planar elevator surface resides below a surface of the body of water.

25. The floating shiplift of claim 20,
wherein the top wall of at least one elevator caisson comprises a step that transitions between a lower surface and an upper surface of the top wall; and
wherein the at least one elevator caisson is positioned relative to the deck such that the lower surface of the top wall resides below the bottom walls of one or more deck caissons.

26. The floating shiplift of claim 16, wherein the additive manufacturing system is disposed on the elevator and coupled thereto.

27. The floating shiplift of claim 16, wherein the additive manufacturing system comprises a 3D printer that successively prints layers of flowable cementitious material on top of each other.

28. The floating shiplift of claim 16, wherein the additive manufacturing system comprises a spraying system that successively sprays layers of flowable cementitious material on top of each other.

29. The floating shiplift of claim 16, wherein the additive manufacturing system comprises a slip-forming system that successively slip-forms layers of flowable cementitious material on top of each other, the slip-formed layers defining respective sections of the cementitious body.

30. The floating shiplift of claim 16, wherein the additive manufacturing system comprises a mixer that mixes fibrous reinforcement materials into the flowable cementitious material.

31. The floating shiplift of claim 16, wherein the additive manufacturing system comprises an assembly system that assembles mesh or cable reinforcement into a support structure that receives the successively deposited layers of flowable cementitious material.

32. A method, comprising:
by operation of an additive manufacturing system of a floating shiplift, depositing successive layers of flowable cementitious material on top of each other to fabricate a cementitious body on an elevator of the floating shiplift, the floating shiplift comprising:
a deck comprising deck caissons that are coupled to each other and floating on a body of water, the deck caissons arranged to define a slip of the deck, the elevator residing in the slip and comprising elevator caissons that are coupled to each other, and
a hoisting system coupling the elevator to the deck and configured to selectively raise and lower and the elevator relative to the deck; and
hardening the flowable cementitious material into a solidified cementitious material, thereby fabricating the cementitious body.

33. The method of claim 32, comprising:
lowering, by operation of the hoisting system, the elevator to a lower position where the elevator resides below a surface of the body of water; and
moving the cementitious body off the elevator into the body of water.

34. The method of claim 33,
wherein each elevator caisson comprises:
top and bottom walls separated by an internal cavity of the caisson, the bottom wall oriented towards the body of water, and
one or more stiffening walls in the internal cavity that extend between the top and bottom walls and partition the internal cavity into a plurality of sub-cavities;
wherein at least one elevator caisson has a buoyancy chamber that comprises one or more sub-cavities of the at least one elevator caisson, the one or more sub-cavities in fluid communication with each other; and
wherein lowering the elevator comprises filling, by operation of a pump of the hoisting system, the buoyancy chamber of at least one elevator caisson with water.

35. The method of claim 32, wherein one or both of the deck caissons and the elevator caissons are each formed of cementitious material and comprise:
top and bottom walls separated by an internal cavity of the caisson, the bottom wall oriented towards the body of water;
a perimeter wall that extends between the top and bottom walls and surrounds the internal cavity, the perimeter wall defining a perimeter of the caisson; and
one or more stiffening walls in the internal cavity that extend between the top and bottom walls and partition the internal cavity into a plurality of sub-cavities.

36. The method of claim 35,
wherein the top walls of the deck caissons have respective top surfaces that are co-planar with each other and define a planar deck surface of the deck; and
wherein the top walls of the elevator caissons define respective top surfaces that are co-planar with each other and define a planar elevator surface of the elevator.

37. The method of claim 36, comprising:
raising, by operation of the hoisting system, the elevator to an upper position where the planar elevator surface is level with the planar deck surface.

38. The method of claim 32,
wherein the additive manufacturing system comprises a 3D printer; and
wherein successively depositing layers comprises successively printing layers of flowable cementitious material on top of each other by operation of the 3D printer.

39. The method of claim 32,
wherein the additive manufacturing system comprises a spraying system; and
wherein successively depositing layers comprises successively spraying layers of flowable cementitious material on top of each other by operation of the spraying system.

40. The method of claim 32,
wherein the additive manufacturing system comprises a slip-forming system; and
wherein successively depositing layers successively slip-forming layers of flowable cementitious material on top of each other by operation of the slip-forming system, the slip-formed layers defining respective sections of the cementitious body.

41. The method of claim 32,
wherein the additive manufacturing system comprises a mixer; and
wherein the method comprises mixing fibrous reinforcement materials into the flowable cementitious material by operation of the mixer.

42. The method of claim 32,
wherein the additive manufacturing system comprises an assembly system; and
wherein the method comprises assembling, by operation of the assembly system, mesh or cable reinforcement into a support structure that receives the successively deposited layers of flowable cementitious material.
